(19) United States
(12) Patent Application Publication
(10) Pub. No.: US 2024/0167171 A1
(43) Pub. Date: May 23, 2024

(54) Electrochemical Methods and Systems for Oxidation of Nitrogenous Compounds

(71) Applicants: Anna KLINKOVA, St. Jacobs, CA (US); Iurii MEDVEDEV, Waterloo (CA)

(72) Inventors: Anna KLINKOVA, St. Jacobs, CA (US); Iurii MEDVEDEV, Waterloo (CA)

(21) Appl. No.: 18/057,082

(22) Filed: Nov. 18, 2022

(51) Int. Cl. C25B 3/23; C25B 3/09; C25B 9/19; C25B 11/061; C25B 11/065; C25B 11/075; C25B 13/04

(52) U.S. Cl. CPC C25B 3/23; C25B 3/09; C25B 9/19; C25B 11/061; C25B 11/065; C25B 11/075; C25B 13/04

(57) ABSTRACT

A system and method for the production of oxidized nitrogenous material from ammonia or urea by electrooxidation on a nickel based catalysts.

### FIELD

The present description relates to a method and system for electrochemical oxidation of ammonia and more particularly to a system and method for electrochemical co-production of hydrogen or syngas and nitrogen fertilizers. More specifically, the method and system relate to a Ni(OH)₂ catalyzed oxidation of ammonia to ammonium nitrate and/or other nitrogen containing products.

### BACKGROUND

Nitrogen-based fertilizers are important compounds for global food security. Over the past 50 years, the use of nitrogen fertilizers increased almost eightfold. However, the continuous growth of nitrogen fertilizer consumption is accompanied by growing emissions of ammonia—a major environmental contaminant that contributes to climate change, eutrophication, as well as to the acidification of water and soil which harms biodiversity. In the atmosphere ammonia can react with other pollutants, such as nitrogen and sulfur oxides leading to the formation of particles, which create smog and have been linked to respiratory problems. Moreover, ammonia contributes to necrosis and enhanced frost sensitivity in a variety of different plant species. Thus, treatment of ammonia-enriched waste originating from agricultural runoff, excess manure, domestic wastewater, food waste, and municipal or industrial sludges is essential to prevent its negative effects on the environment.

Anaerobic digestion (AD) represents a cost-effective technology for large-scale treatment of waste streams (up to several thousand m³) with the formation of biogas—primarily the mixture of methane (CH₄) and carbon dioxide (CO₂). Recently, much attention has been paid to the simultaneous recovery of nutrients (N and P) in AD plants, which is essential from both environmental and economic perspectives. Due to the significantly higher concentration of N compared to P in the organic waste, the majority of recent studies were predominantly focused on N recovery technologies.

The strategy for the utilization of nitrogen-containing waste within AD consists of three main steps: 1) anaerobic digestion, 2) membrane separation, and 3) the treatment of ammonia. In the first step, organic carbon and nitrogen (obtained from sources such as manure, food waste, other organic waste and wastewater) are broken down by microorganisms to biogas and NH₄⁺. In the second step, NH₄⁺ is concentrated in a membrane contractor for further treatment. In the third step ammonia can be either completely removed from the liquid phase or transformed into recycled fertilizers.

The most commonly applied approach to treat N-waste in wastewater treatment plants is the conversion of NH₄⁺ to nontoxic nitrogen gas (N₂). Several conventional ammonia removal techniques can be used for this purpose, including biological treatment, wet oxidation, and breakpoint chlorination. Breakpoint chlorination is an excellent method for ammonia removal due to its low capital costs, high efficiency, and the ability to beneficially sanitize the water at the same time. Despite the effectiveness of this approach, the transformation of ammonia into N₂ leads to a loss of N resources. Another established approach that is used in conjunction with anaerobic digestion is the conversion of ammonia into an ammonium salt form. In this case, NH₃ is recovered from concentrated NH₄⁺ solution in ammonia stripper followed by its reaction with sulfuric acid to produce (NH₄)₂SO₄ that could be used as a fertilizer. In principle, ammonia recovered in a stripper can be used directly as a fertilizer. The latter approach has been popular for soil fertilization in the past couple of decades due to the highest nitrogen content in this compound. However, pure ammonia is hazardous and must be stored and handled under high pressure. Consequently, due to the strict regulations of ammonia use, less toxic solid ammonium salt fertilizers have displaced pure ammonia in agricultural practices.

Simultaneous (NH₄)₂SO₄ production has been already implemented in some operational AD facilities. Furthermore, the heat produced in this reaction may be used as an additional energy source for the whole system maintenance. The primary drawback of this approach is that the obtained fertilizer has a high sulfur content which is restricted in many municipalities due to its harmful environmental effects including acid rain and soil acidification which harms sensitive ecosystems. Thus, it is critical to lower the sulfur content of the produced fertilizer. In principle, NH₄NO₃ can also be synthesized by this method as well if sulfuric acid is replaced by nitric acid. However, due to the substantially higher costs of HNO₃ the gross profit of this synthesis is more than 4 times lower than that to produce (NH₄)₂SO₄, making this option less economically attractive.

It has been found that NH₄NO₃ can be synthesised directly from ammonia via its partial electrooxidation, which does not require the addition of nitric acid. Additionally, it has been found that the oxidation of ammonia to nitrate at the anode can be coupled with a value-added process at the cathode, such as green hydrogen production (or hydrogen evolution reaction, HER) or electrochemical CO₂ reduction (CO₂R) to fuels or valuable carboxylic acids.

Electrochemical oxidation of ammonia (AOR) has gained significant attention over the last decade as an anodic reaction for alkaline membrane-based fuel cells (AMFCs), where ammonia breaks down to N₂. AMFCs are considered to be a promising competitor to traditional hydrogen fuel cells due to the high energy density of ammonia and the low standard oxidation potential of AOR to N₂. For the same reasons, AOR to N₂ is a promising anodic reaction for HER and CO₂R electrolyzers. Therefore, many studies have focused on improving the efficiency of AOR to N₂, while AOR to other N-containing products is underexplored.

It has been previously demonstrated that AOR on Ni-based catalysts can yield nitrite and nitrate in addition to N₂. The performance of various Ni-based catalysts has been reported but due to the inconsistency in the catalyst composition, reaction conditions, and the types of electrochemical cells used in these studies, it remains unclear how operating parameters affect AOR efficiency and selectivity, and what the key to the efficient production of nitrate is using AOR.

Several mechanisms have been reported for ammonia oxidation at Ni(OH)₂ anodes. The adsorption of ammonia to the catalyst surface is typically considered to be the first step of the reaction. Some studies suggest that adsorbed ammonia further undergoes deprotonation steps to form N_{ads}, which can be either coupled to form N₂ or oxidized to form NOₓ species. Other studies propose that the formation of N₂ may occur via dimerization of intermediate *NH or *NH₂ species followed by the deprotonation of corresponding dimers N₂Hₓ. Alternatively, NH₃ can be oxidized to NH₂OH species, a subsequent oxidation of which leads to NOₓ species. Although these earlier studies proposed several possible pathways for the formation of different AOR products, it remains unclear which intermediate is responsible for the formation of each particular product. Recently reported first principles simulations of AOR mechanisms to N₂, NO₂⁻, and NO₃⁻ on β-Ni(OH)₂ showed that the formation of N₂ proceeds via NH—NH coupling (Gerischer-Mauerer mechanism), while the formation of NO products occurs via the deprotonation of NH₃ to N_{ads} followed by the subsequent hydroxylation steps. Nevertheless, the role of the electrocatalyst in the AOR process has not been completely understood due to the lack of mechanistic studies of AOR on Ni-based catalysts.

On the other hand, nucleophile electrooxidation (e.g., oxidation of ethanol or urea) at nickel-based catalysts has been well studied. In contrast to OER, these electrochemical reactions represent two-step, one-electron processes: electrochemical catalyst dehydrogenation and a nonelectrochemical spontaneous nucleophile dehydrogenation, i.e., a chemical reaction between NiOOH and the H-containing nucleophile. Interestingly, it has been established that even OER can proceed spontaneously on the NiOOH surface, but only at elevated temperatures (at temperatures below 70° C. spontaneous OER proceeds slowly).

Typical electrolyzer operation for producing hydrogen gas or reducing CO₂ to valuable carbon-based products (e.g., syngas, CO, ethylene) relies on a concomitant water oxidation reaction resulting in oxygen evolution at the anode; membranes are used to separate the cross-over of the reduced and oxidized species to the counter electrodes where they can undergo the reversed process, thereby reducing the system efficiency. Recently a membrane-free electrolytic reactor in which the cathodic the hydrogen production and water oxidation to oxygen gas were separated into two steps, electrochemical to produce hydrogen and thermally-activated chemical to produce oxygen gas; such reactor operates in so-called swing mode, where the two steps are repeated sequentially, and the anode material essentially works as a solid redox mediator. The downside of this approach is the need to heat the medium to 95° C. to initiate the process.

Accordingly, there is a need for new methods to control the oxidization of ammonia to form nitrogen products including nitrite, nitrate and N₂. In particular, there is a need to establish methods to control AOR product selectivity to efficiently generate NH₄NO₃ which may be used as a fertilizer from recycled ammonia. There is also a need for new methods to vary the N—P—K (—S) value in the resulting fertilizer. Further, there is a need to integrate controlled AOR into an electrolyzer for simultaneously producing hydrogen gas or reducing CO₂ to value-added products at the cathode.

### SUMMARY

In one aspect there is provided, a system for electrochemical oxidation of ammonia comprising:

a divided cell having at least two compartments an anodic compartment and a cathodic compartment; said compartments separated by an anion exchange membrane (AEM);

the anodic compartment comprising an anode comprising a nickel containing catalyst and a first electrolyte for oxidative electrolysis of ammonia;

the cathodic compartment comprising a cathode and a second electrolyte for reductive electrolysis of hydrogen or carbon dioxide, and
wherein the anodic compartment has a pH of 9-12 and the cathodic compartment has a pH≥13.

In another aspect there is provided a method for electrochemical co-production of hydrogen or syngas and nitrogen fertilizer, the method comprising:
providing a divided cell having at least two compartments an anodic compartment and a cathodic compartment; said compartments separated by an anion exchange membrane (AEM) the anodic compartment comprising a nickel based catalyst;
introducing ammonia in an electrolyte at pH 9-12 in the anodic compartment of the divided cell;
introducing water or wet CO₂ in an electrolyte at pH≥13 into the cathodic compartment of the divided cell; and
applying a potential to electrooxidize the ammonia into ammonium nitrate at the anode while reducing the water or wet CO₂ to hydrogen gas or syngas at the cathode.

In still a further aspect there is provided, a method for oxidizing a nitrogen containing compound in a swing mode electrolyzer comprising:
a first step of applying a potential to a nickel catalyst to activate the catalyst and form NiOOH and then discontinuing the applied potential; and
a second step of contacting the activated catalyst with a solution comprising the compound to be oxidized and an electrolyte to oxidize the compound without the further application of potential.

### BRIEF DESCRIPTION OF THE DRAWINGS

Embodiments will now be described with reference to the appended drawings wherein:

FIG. 1 (a) is a scheme depicting a brief summary of the major electrochemical AOR pathways and products. FIG. 1 (b) is a graph showing major products and corresponding current densities during AOR at various reported Ni-based AOR catalysts.

FIGS. 2 (a, b, c, and d) are graphs showing the determination of double-layer capacitance Ni plate (FIG. 2 (a) and FIG. 2 (c)) and Ni foam (FIG. 2 (b) and FIG. 2 (d)) in 1M KOH (CVs taken over a range of scan rates; and currents due to double-layer charging plotted against scan rate). FIG. 2 (e) is a chart showing double-layer capacitance values and roughness factors of Ni materials.

FIG. 3 (a) is a photograph of a freshly cleaned Ni foam; FIG. 3 (b) is a photograph of the prepared Ni(OH)₂/NF anode.

FIG. 4 (a) is a diagram of a Randles circuit used for the interpretation of impedance spectra, consisting of the resistance of solution, double layer capacitance at the surface of the electrode as well as charge transfer resistance. FIG. 4 (b) is Nyquist impedance spectra recorded for the Ni(OH)₂/NF anode during the OER at different potentials; FIG. 4 (c) is Nyquist impedance spectra recorded for the Ni(OH)₂/NF anode during the or AOR at different potentials.

FIG. 5 (a) is graphs of LSV is recorded at 1 mV s⁻¹ scan rate at Ni(OH)₂ anode for electrolyte solutions containing 0.2 M NH₃ in 0.1 M Na₂SO₄. FIG. 5 (e) is graphs of LSV is recorded at 1 mV s⁻¹ scan rate at Ni(OH)₂ anode for electrolyte solutions containing 0.2 M NH₃ in 0.1 M NaOH. FIG. 5 (b) is a chronoamperometry plot for the electrolysis of 0.2 M NH₃ at different potentials in 0.1 M Na₂SO₄. FIG. 5 (f) is a chronoamperometry plot for the electrolysis of 0.2 M NH₃ at different potentials in 0.1 M NaOH. FIG. 5 (c) is a graph of faradaic efficiencies of the major products as a function of applied potential in 0.1 M Na₂SO₄ FIG. 5 (g) is a graph of faradaic efficiencies of the major products as a function of applied potential in 0.1 M NaOH. FIG. 5 (d) is a graph of faradaic efficiencies of the major products as a function of pH; FIG. 5 (h) is a graph of faradaic efficiencies of the major products as a function of starting NH₃ concentration.

FIG. 6 is a graph depicting ammonia to ammonium molecular ratio as a function of solution pH.

FIG. 7 (a-d) are graphs of non-electrochemical oxidation of NH₃ to NO₂⁻ by electrogenerated NiOOH catalyst: charging and discharging steps along with the product analysis. FIG. 7 (e) is a graph of LSV recorded at 10 mV s⁻¹ scan rate at Ni(OH)₂ anode for 0.1 M Na₂SO₄ solutions containing 0.2 M NH₃ and 0.1 M NaNO₂ compared to the solution without any additives (for all solutions pH was adjusted to 11.3 by adding an appropriate amount of NaOH). FIG. 7 (f) is an illustration of the electrochemical and chemical steps involved in NH₃ oxidation at Ni(OH)₂/NF catalyst. FIG. 7 (g and h) are charts of AOR current densities and the product distribution at 1.55 V and 1.9 V vs RHE as a function of temperature.

FIG. 8 (a) is a diagram showing a cell view and ion transport in the electrolyzer used for the preparative electrolysis of NH₃. FIG. 8 (b) is a graph showing the effect of catholyte on the stability of AOR. Electrolysis of 0.2 M ammonia in 0.1 M K₂SO₄ anolyte with 0.1 M K₂SO₄ (grey trace) and 1 M KOH (black trace) used as catholytes (reactions were performed at 1.9 V (grey trace) and 2.1 V (black trace)). FIG. 8 (c) is a graph of preparative electrolysis of 0.3 M ammonia in 0.1 M K₂SO₄ performed at 1.9 V. FIG. 8 (d) is a graph of the anolyte composition before electrolysis and FIG. 8 (e) is a graph of the ion concentrations after the electrolysis.

FIG. 9 (a) is a graph of the pH changes in the catholyte and anolyte after 20 h electrolysis. FIG. 9 (b) is a graph of the changes in SO₄²⁻ and NO₃⁻ concentrations in anolyte after 20 h electrolysis. (Electrolysis was performed using NF cathode and 1.5 cm² Ni(OH)₂/NF anode using 0.1 M Na₂SO₄ as electrolyte for both compartments.)

FIG. 10 (a) is a graph of a UV-Vis spectra of aqueous [Ni(NH₃)₆]Cl₂, and reaction mixtures after the preparative electrolysis of 0.3 M NH₃ in 0.1 M Na₂SO₄ at 1.9 V and 2.1 V; FIG. 10 (b) is a photo of the solutions after the preparative electrolysis; FIG. 10 (c) is a graph of LSV curves recorded at 1 mV; s⁻¹ scan rate at Ni(OH)₂/NF catalyst (before the preparative electrolysis) and after for 0.2 M NH_{3+0.1} M Na₂SO₄ solution.

FIG. 11 (a) is a graph of a preparative electrolysis of 0.3 M ammonia in 0.1 M K₂HPO₄ performed at 1.9 V vs RHE; FIG. 11 (b) is a graph of the anolyte composition after the electrolysis where the grey bars correspond to the NH₃ concentration before and after electrolysis and the other bars represent the concentrations of ions after the electrolysis. Electrolysis was performed using 5 cm² Ni(OH)₂/NF anode.

FIG. 12 depicts paired electrolysis of ammonia and CO₂. FIG. 12 (a) is a photograph of an electrochemical flow cell used for the co-electrolysis of ammonia and CO₂. FIG. 12 (b) is depicts a cell view of a [CO₂R|AOR] electrolyzer. FIG. 12 (c) is a graphs of the chronoamperometry plots for the electrolysis of 0.1 MK₂SO₄+0.3 M NH₃ at Ni(OH)₂/NF anode at different potentials. FIG. 12 (d) is a graph of the Faradaic efficiencies of the major products of CO₂R and AOR as a function of applied cathode potential.

FIG. 13 The effect of pH on the AOR, OER, and nitrite oxidation at Ni(OH)₂/NF anode. FIG. 13 (a-c) are graphs of LSV recorded at 10 mV s⁻¹ at Ni(OH)₂/NF in 0.1 M Na₂SO₄, containing 0.2 M NH₃/NH₄⁺ (a), 0.1 M NaNO₂ (b), and without any additives (c). Electrolytes with pH 9-12 were prepared by adjusting pH of the electrolyte by the addition of sulfuric acid or sodium hydroxide. For the reactions at pH 13 and 14, 0.1 M NaOH and 1 M NaOH were used as electrolytes. (d-e) Relative activity of AOR, nitrite oxidation, OER at Ni(OH)₂/NF anode at different pH: 10 (d), 12 (e), 13 (f).

FIG. 14 is a graph of electrolysis of 0.01 M NaNO₂ in 0.1 M Na₂SO₄ at 1.9 V vs RHE and pH 11.3 (pH was adjusted by adding an appropriate amount of Na₀H).

FIG. 15 (a) is a graph of charging of Ni_{0.9}Co_{0.1}(OH)₂ anode in 5M KOH at 50 mA cm⁻². Potential zones that correspond to different processes; FIG. 15 (b) is a graph of stability of electrochemical charging/discharging at ±50 mA cm⁻²; FIG. 15 (c) is a chart showing the results of chemical discharge in 0.33M urea+0.1M NaOH of electrogenerated Ni_{0.9}Co_{0.1}OOH, showing good reproducibility.

FIG. 16 (a) is a graph of charging of Ni(OH)₂ and Ni_{0.9}Co_{0.1}(OH)₂ anodes in 5M KOH at 50 mA cm⁻²; FIG. 16 (b) is a graph of stability of electrochemical charging/discharging showing good proof of stability of NiOOH even in 5M KOH at r.t. (Note: The anode was not completely discharged.)

FIG. 17 is a graph of the concentration of NO₂⁻ over time for spontaneous UOR over NiOOH in 0.1 M KOH.

FIG. 18 is a graph of the concentration of NO₂⁻ over time for spontaneous AOR over NiOOH in 0.1 M KOH.

FIG. 19 (a) is a chart of the concentration of NO₂⁻ relative to temperature obtained for spontaneous UOR and AOR in 0.1 M KOH, containing 0.33 M urea or 0.33 M ammonia; FIG. 19 (b) and FIG. 19 (c) show the determination of the spontaneous AOR (b) and UOR (c) activation energies using Arrhenius equation and are graphs representing a linear relation between In k (k—reaction rate constant) and 1/T (T—temperature) where the slope of In k (1/T) function is—Eₐ/R, where R=8.31 J K⁻¹ mol⁻¹

FIG. 20 is a gas chromatogram of the reaction headspace obtained after spontaneous UOR.

FIG. 21 (a) is a graph of concentration of UOR products over time in Milli-Q water (neutral pH) at 35° C. FIG. 21 (b) is a graph of the molar ratio of NCO⁻/NOₓ⁻ relative to time at neutral pH and alkaline media.

FIG. 22 (a) is a graph of concentration of spontaneous UOR products relative to time in 0.1M K₂SO₄; FIG. 22 (b) is a graph of concentration of spontaneous UOR products relative to time in in 0.1M KCl. FIG. 22 (c) is a chart showing NO₃ concentration in different reaction media.

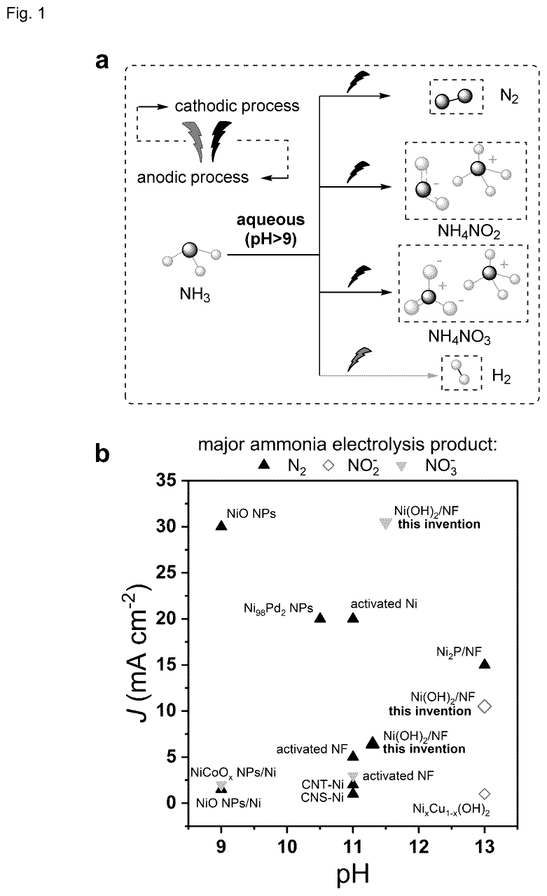

### DETAILED DESCRIPTION

### Definitions

As used herein the term “Ammonia Oxidative Reaction” or “AOR” refers to the electrochemical oxidation of ammonia to nitrite, nitrate and/or N₂.

As used here in the term “Oxygen Evolution Reaction” or “OER” refers to the electrochemical oxidation of water to form O₂.

As used here in the term “Hydrogen Evolution Reaction” or “HER” refers to the electrochemical reduction of water to form H₂.

As used herein the term Faradic Efficiency or FE refers to the efficiency with which charge is transferred within a system in a system facilitating an electrochemical reaction.

Unless stated otherwise herein, the articles “a” or “the”, when used to identify an element, are not intended to constitute a limitation of just one and will, instead, be understood to mean “at least one” or “one or more”. Thus, unless stated otherwise, as used in this specification and the appended claims, the singular forms “a”, “an”, and “the” will be understood to include the plural form. For example, reference to “a container” will be understood to include one or more of such containers and reference to “the excipient” will be understood to include one or more of such excipients.

As used herein, the term “about” is synonymous with “approximately” and is used to provide flexibility to a numerical value or range endpoint by providing that a given value may be “a little above” or “a little below” the value stated. “About” can mean, for example, within 3 or more than 3 standard deviations. “About” can mean within a percentage range of a given value. For example, the range can be ±1%, ±5%, ±10%, ±20%, ±30%, ±40% or ±50% of a given value. “About” can mean with an order of magnitude of a given value, for example, within 2-fold, 3-fold, 4-fold, or 5-fold of a value. However, it is to be understood that even when a numerical value is accompanied by the term “about” in this specification, that express support shall be provided at least for the exact numerical value as well as though the term “about” were not present.

The terms “comprise”, “comprises”, “comprised” or “comprising” may be used in the present description. As used herein (including the specification and/or the claims), these terms are to be interpreted as specifying the presence of the stated features, integers, steps or components, but not as precluding the presence of one or more other feature, integer, step, component or a group thereof as would be apparent to persons having ordinary skill in the relevant art. Thus, the term “comprising” as used in this specification means “consisting at least in part of”. When interpreting statements in this specification that include that term, the features, prefaced by that term in each statement, all need to be present but other features can also be present. Related terms such as “comprise” and “comprised” are to be interpreted in the same manner.

The term “and/or” can mean “and” or “or”.

As used herein, “comprises,” “comprising,” “containing” and “having” and the like can have the meaning ascribed to them in patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with patent law.

The phrase “consisting essentially of” or “consists essentially of” will be understood as generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term, such as “comprising” or “including”, it will be understood that direct support should be afforded also to “consisting essentially of” language as well as “consisting of” language as if stated explicitly and vice versa. In essence, use of one of these terms in the specification provides support for all of the others.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but to also include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but to also include individual values and sub-ranges within the indicated range. Thus, included in this numerical range are individual values such as 2, 3, and 4 and sub-ranges such as from about 1 to about 3, from about 2 to about 4, and from about 3 to about 5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

It has been found that NH₃ can be oxidized by electrooxidation to form various nitrogen containing species and the degree of oxidation and resulting products can be controlled by controlling various reaction parameters. The reaction parameters include the catalyst selection, electrolyte pH and nature, applied potential, temperature and starting NH₃ concentration.

It has further been found that NH₄NO₃ can be synthesised directly from ammonia via its partial electrooxidation, which does not require the addition of nitric acid. Additionally, it has been found that through selection of various parameters of the method, efficient electrosynthesis of NH₄NO₃ from ammonia can be achieved. In still a further aspect it has been found that the electrolysis conditions and specifically the electrolyte composition can be selected to result in the formation of ammonium nitrate in mixture with only K and P (or K and S) containing compounds to yield final products that can be directly used as a fertilizer.

In a further aspect the oxidation of ammonia to nitrate at the anode can be coupled with a value-added process at the cathode, such as green hydrogen production (or hydrogen evolution reaction, (HER) or electrochemical CO₂ reduction (CO₂R) to fuels or valuable carboxylic acids.

In one embodiment there is a system for electrochemical oxidation of ammonia in a divided cell having at least two compartments an anodic compartment and a cathodic compartment. The compartments are separated by an anion exchange membrane. The anodic compartment comprising an anode and a first electrolyte for oxidative electrolysis of ammonia. The cathodic compartment comprising a cathode and a second electrolyte for reductive electrolysis of hydrogen or carbon dioxide. The anodic compartment has a pH of about 9-12 and the cathodic compartment has a pH of 13.

Various anode catalyst materials are known in the art and can be used. For example, the catalyst can be a nickel catalyst. In a particular embodiment the nickel catalyst is Ni(OH)₂, or Ni(OH)Cl. In a further aspect the nickel catalyst is supported on a porous surface to increase surface area such as Ni foam, or porous carbon. In still a further aspect the nickel catalyst is optionally doped with other metals. The doped catalyst can have the formula NiₓM₁₋ₓ(OH)₂ where dopants include M=Cr, Mn, Fe, Co, Cu, Zn, W, or Mo. In a particular aspect the catalyst is a Ni(OH)₂ coated on a high surface area nickel foam.

In another aspect, the catholyte (electrolyte at the cathode compartment) may be selected to tune the cathode reaction. In one embodiment a highly alkaline catholyte is used to suppress anolyte acidification during electrochemical oxidation of ammonia. Examples of catholytes include potassium hydroxide, sodium hydroxide, cesium hydroxide or another strong base. In a particular embodiment the catholyte is potassium hydroxide.

In another aspect, the anolyte (electrolyte at the anode compartment) may be selected to tune the anode reaction. In one embodiment the anolyte is non-alkaline and comprises ammonia. Examples of anolytes include potassium sulfate and dipotassium phosphate. In a particular aspect the anolyte is dipotassium phosphate.

In another aspect, the applied potential is greater than 1.3 V in order to activate Ni. In a further aspect the applied potential is below about 2.1 V to prevent anode degradation. In a particular aspect the applied potential is in a range of about 1.3-2.0 V vs RHE. In a further aspect an applied potential of about 1.7 to about 1.9 V is used to increase nitrate production, while an applied potential of about 1.4 to about 1.6 V is used to increase nitrite production.

While the reaction can proceed in over a wide temperature range from about 5° C. to about 95° C., in a further aspect, the temperature can be used to target the production rate and efficiency of certain products. At low potentials (<1.6V), nitrite production is favoured at <50° C., while an increased temperature favours nitrate production. At high potentials, nitrate production is favoured over nitrite at all temperatures, whereas the nitrate production rate increases with the increasing temperature.

In another aspect, the NH₃ starting concentration can be varied to tune the reaction. Ammonia concentrations up to about 1M ammonia can be used to obtain nitrate (or nitrite) as the predominant product. When the starting concentration of ammonia is increased above about 1M, the formation of dinitrogen gas becomes dominant. When the starting concentration of ammonia is below about 1M, the temperature may be adjusted to drive the formation of either nitrate or nitrite as described above.

Preparation of the Anode

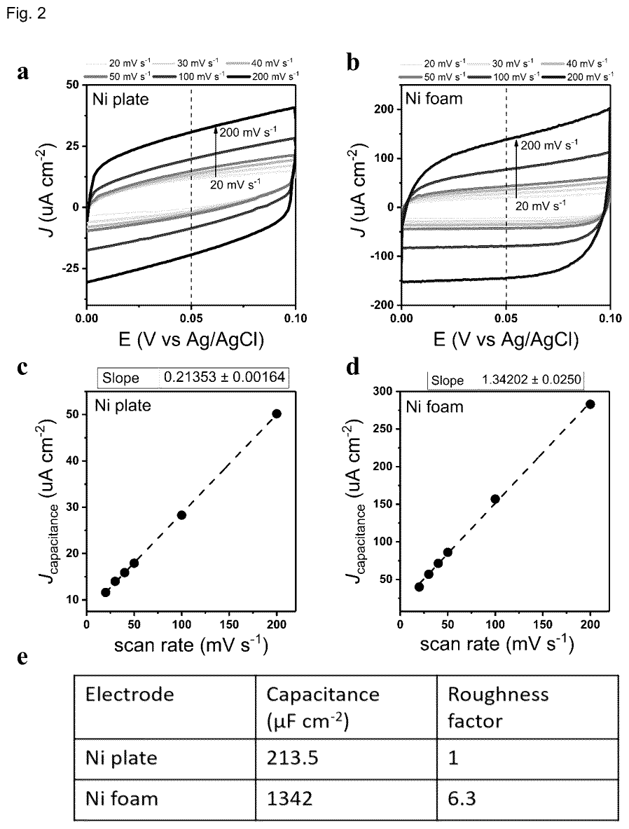

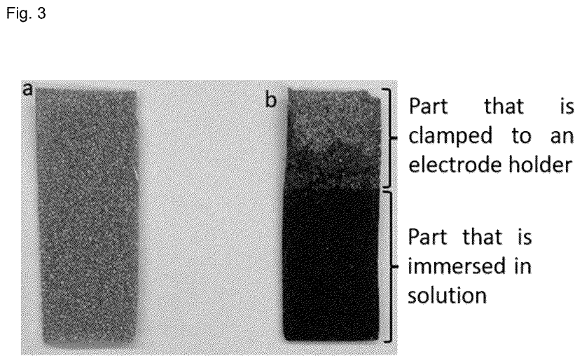

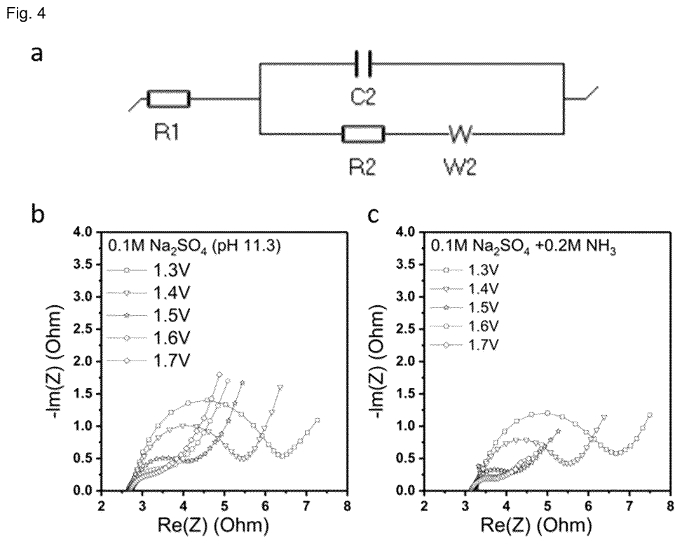

A catalysts comprising Ni(OH)₂ on nickel foam has been developed and found to be highly effective. A nanostructured Ni(OH)₂ xerogel catalyst has been prepared using an optimized epoxide sol-gel synthesis method previously reported by the co-inventors (S. W. Tatarchuk, R. M. Choueiri, X. V. Medvedeva, L. D. Chen and A. Klinkova, Chemosphere, 2021, 279, 130550.) This approach has been chosen due to its scalability, high availability of precursors, and the ability to produce materials with a high degree of structural and compositional homogeneity. A catalyst ink made of Ni(OH)₂ xerogel catalyst, carbon black and Nafion was deposited on a 3D scaffold of Ni foam (NF), which was chosen due to its high surface area, high conductivity and good mechanical strength. The performance of various Ni-based electrocatalyst materials in electrochemical ammonia oxidation was studied. The results of the study are disclosed in Table 1. The comparison of double-layer capacitance of NF and flat Ni surface (polished Ni plate) revealed that the foam had than 6.3-times higher surface area (FIG. 2). High catalyst loading (˜10 mg per 1×1 cm⁻² piece of NF with 0.15 cm thickness) ensured full coverage of the Ni support, minimizing its direct involvement in the electrochemical reaction (FIG. 3). The electron transfer properties of prepared Ni(OH)₂/NF catalyst were studied via electrochemical impedance spectroscopy (FIG. 4 and Table 2).

TABLE 1

| Anode | E or J | | pH | Electrolyte | Results | Ref. |
|---|---|---|---|---|---|---|
| Ni₉₈Pd₂ | 20 | mA cm⁻² | 10.5 | 0.2M NH₄NO₃ + | FE_{(N2)} 38.7% | [3] |
| | | | | 1M NaNO₃ | | |
| NF^{a} | 0.7 | V_{Hg/HgO} | 11 | 20 ppm NH₃ + | FE_{(N2)} 50% | [4] |
| | | | | 0.1M Na₂SO₄ | | |
| NF^{a} | 0.85 | V_{Hg/HgO} | 11 | 20 ppm NH₃ + | FE(NO₃⁻) 10% | [4] |
| | | | | 0.1M Na₂SO₄ | | |
| Activated Ni | 20 | mA cm⁻² | 11 | 50 mM NH₄ClO₄ + | No FEs are given. | [5] |
| | | | | 1M NaClO₄ | 3:1 N₂/NO₃⁻ ratio | |
| Ni₂P/NF | 15 | mA^{b} | 13 | 1000 ppm NH₃ + | Up to 50% CE without | [6] |
| | | | | 0.1M KOH | specification (N₂ major; NO₂⁻, | |
| | | | | | NO₃⁻ ~1:1) | |
| NiₓCu₁₋ₓ(OH)₂ | 1.53 | V_{RHE} | 13 | 1 mM NH₃ + | >80% FE of NO₂⁻ | [7] |
| | | | | 0.1M KOH | minor oxidation of NH₃ was | |
| | | | | | observed without applied | |
| | | | | | voltage | |
| CNT-Ni^{c} | 1.5 | V_{RHE} | 11 | 130 ppm NH₃ + | No FE are given. | [8] |
| | | | | 10 mM Na₂SO₄ | ~14:1 N₂/NO₃⁻ ratio | |
| CNS-Ni^{d} | 1.5 | V_{RHE} | 11 | 130 ppm NH₃ + | No FE are given. | [8] |
| | | | | 10 mM Na₂SO₄ | ~16:1 N₂/NO₃⁻ ratio | |
| CuCo/NF | 1.1 | V_{Ag/AgCl} | 11 | 450 ppm NH₃ + | Up to 80% | [9] |
| | | | | 10 mM Na₂SO₄ | (4:1 N₂/NO₃⁻ ratio) | |
| NiO NPs | 30 | mA cm⁻² | 9 | 200 mM NH₄OH + | No FE are given. | [10] |
| | | | | 100 mM NaNO₃ | N₂ major. NO₂⁻:NO₃⁻ ~1:2 | |
| NiO NPs/NF | 2 | mA cm⁻² | 9 | 100 ppm NH₃ + | 80% removal; 90% N₂ | [11] |
| | | | | 0.1M Na₂SO₄ | selectivity | |
| NiCo oxide | 2 | mA cm⁻² | 9 | 130 ppm NH₃ + | 98% removal. | [11] |
| NPs/Ni | | | | 0.1M Na₂SO₄ | 80% NO₃⁻ selectivity | |

| | | | | | |
|---|---|---|---|---|---|
| Ni(OH)₂/NF | 1.6 V_{RHE} | 11.3^{f} | 0.2M NH₃ + | FE_{(N2)} 51% | Present |
| | (~6 mA cm⁻²)^{e} | | 0.1M Na₂SO₄ | | application |
| Ni(OH)₂/NF | 1.9 V_{RHE} | 11.5^{f} | 0.3M NH₃ + | FE(NO₃⁻) 72%^{g} | Present |
| | (~30.5 mA cm⁻²)^{e} | | 0.1M K₂SO₄ | | application |
| Ni(OH)₂/NF | 1.6 V_{RHE} | 13^{f} | 0.2M NH₃ + | FE(NO₂⁻) 58% | Present |
| | (~10 mA cm⁻²)^{e} | | 0.1M NaOH | | application |

^{a}Nickel foam;
^{b}current is reported instead of current density;
^{c}CNT is carbon nanotubes;
^{d}CNS is carbon nanospheres;
^{e}Average current density in the first two hours of electrolysis.
^{f}Initial pH of the electrolyte.
^{g}Total FE in the end of 52 h electrolysis.

TABLE 2

| E | | Rₛ | C_{dl} | R_{ct} | W |
|---|---|---|---|---|---|
| (V vs RHE) | Reaction | (Ohm) | (mF) | (Ohm) | (Ohm s^{-1/2}) |
| 1.3 | OER | 2.761 | 1.59 | 3.136 | 1.037 |
| 1.4 | OER | 2.762 | 1.62 | 2.227 | 1.205 |
| 1.5 | OER | 2.775 | 2.43 | 1.142 | 1.349 |
| 1.6 | OER | 2.772 | 2.83 | 0.727 | 1.353 |
| 1.7 | OER | 2.775 | 2.51 | 0.548 | 1.394 |
| 1.3 | AOR | 3.302 | 1.62 | 2.792 | 1.124 |
| 1.4 | AOR | 3.297 | 1.494 | 1.856 | 1.016 |
| 1.5 | AOR | 3.245 | 1.987 | 0.845 | 0.907 |
| 1.6 | AOR | 3.225 | 2.705 | 0.602 | 0.739 |
| 1.7 | AOR | 3.21 | 3.108 | 0.561 | 0.592 |

Optimum fit parameters for the impedance data of Ni(OH)₂/NF electrode in OER (0.1M Na₂SO₄) and AOR (0.1M Na₂SO₄ + 0.2M NH₃) systems, where Rs is solution resistance, Cdl is double layer capacitance at the surface of the electrode, Rct is charge transfer resistance, and W is Warburg resistance.

Operating Parameters:

Ammonia can be converted into other N-containing products via either direct or indirect electrooxidation. The latter approach involves the oxidation of ammonia in the solution by the electrogenerated strong oxidants, such as HCIO and • OH. Usually, this process proceeds in acidic media, where ammonia is present in the non-electrochemically active NH₄⁺ form. To understand the progression of the direct AOR without the contribution of this indirect pathway, the reactions were performed at pH 9, where the NH₄⁺/NH₃ equilibrium favors NH₃, which can be adsorbed at the electrocatalyst surface.

To exclude the possibility of reducing AOR products at the cathode, a divided electrochemical cell with two compartments separated by an anion-exchange membrane (AEM) was used for all experiments.

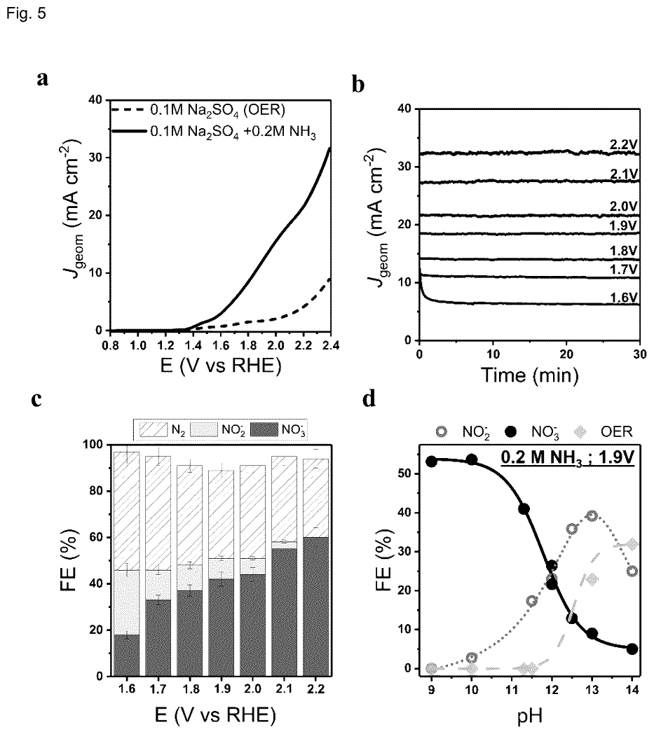

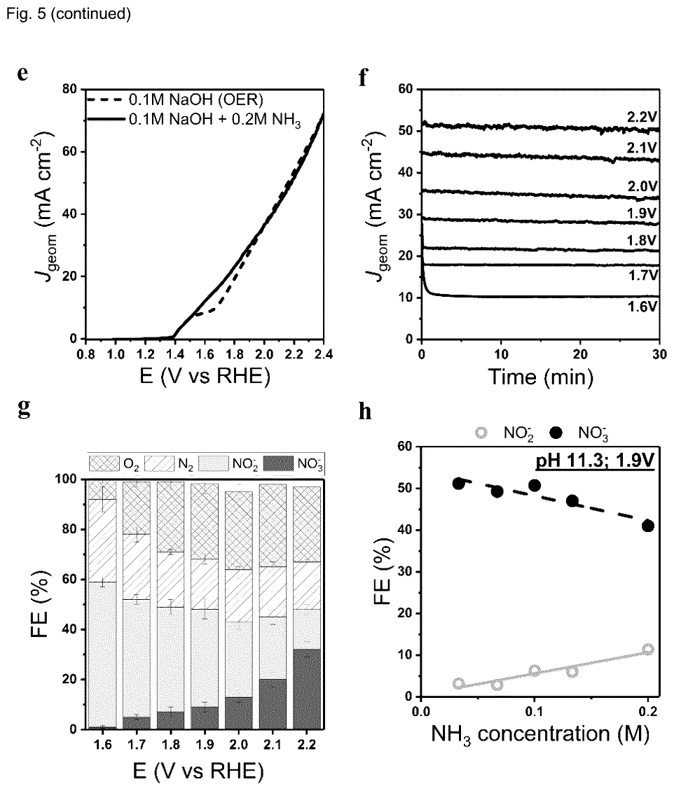

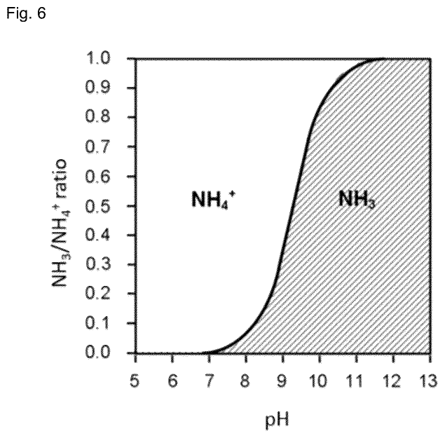

To elucidate the effect of electrolyte nature on the electrochemical behavior of NH₃ at Ni(OH)₂/NF anode, electrochemical studies of AOR were carried out in two different electrolytes: 0.1 M Na₂SO₄ and 0.1 M NaOH, both containing 0.2 M ammonia (FIG. 5). Both these solutions had pH>11 and, therefore, the NH₄⁺/NH₃ equilibrium favored NH₃ in both cases (FIG. 6). Na₂SO₄ was chosen as an inert electrolyte, while NaOH was chosen as an alkaline electrolyte with a high concentration of OH⁻ to probe whether these species can promote NH₃ deprotonation steps. A high concentration of NH₃ (0.2 M) was used in both cases to avoid the NH₃ concentration changes affecting the reaction outcome in short-term electrolysis.

To select meaningful potentials for the potentiostatic electrolysis, the electrochemical behavior of NH₃ at Ni(OH)₂/NF anode was investigated by performing linear sweep voltammetry (LSV) in 0.1 M Na₂SO₄ and 0.1 M NaOH solutions, containing 0.2 M NH₃ (FIG. 5 (a) and FIG. 5 (e)). The relative activity of AOR and oxygen-evolution reaction (OER) in these electrolytes, are shown by comparing the results to NH₃-free solutions with the same pH (adjusted by adding an appropriate amount of 1 M NaOH). In the alkaline medium in the absence of ammonia, Ni^{2+/3+} wave was observed at 1.4-1.65 V followed by OER wave at more positive potentials. The onset potential for AOR was the same as for Ni^{2+/3+} transition (˜1.4 V vs. RHE; FIG. 5 (e)). In contrast, a completely different behavior of AOR and OER curves was observed in 0.1 M Na₂SO₄ (FIG. 5 (a)). The LSV curve for the NH₃-free solution had two peaks at 1.4-1.6 V and 1.6-1.8 V, which are typically attributed to Ni(OH)₂ oxidation to γ- and β-NiOOH.(42) The OER wave appeared at E>1.8 V, although the current density was smaller than that for AOR. In addition to higher current density, AOR onset potential was significantly lower (˜1.5 V) than that for OER. These results indicated that in 0.1 M Na₂SO₄ AOR can be performed with little to no OER over a wide range of potentials, in contrast to the alkaline medium. While not wishing to be bound by theory, it is believed that this is due to ammonia having a higher affinity to the electrode surface compared to OH⁻ species, and thus mainly AOR is expected until most NH₃ is depleted.

To evaluate the influence of the applied potential on the AOR product distribution, a series of the potentiostatic electrolysis of ammonia were performed in both electrolytes at the potentials ranging from 1.6 V to 2.2 V (FIG. 5 (b, c, f and g)). All reactions were conducted with the initial concentration of NH₃ of 0.2 M and Ni(OH)₂/NF as an anode. The gas products (N₂ and O₂) were analyzed using in-line gas chromatography (GC) every 20 min, while non-volatile AOR products (NO₂, NO₃⁻) were analyzed by ion chromatography (IC). IC was employed for the determination of faradaic efficiencies (FEs) for different products as a quantitatively accurate method, suitable for the analysis of trace amounts of nitrite and nitrate. In an alternative embodiment the analysis of nitrates and nitrites can be performed by operando UV-Vis.

In agreement with the LSV data, no O₂ formation was observed in the reaction headspace during AOR in 0.1 M Na₂SO₄ for all studied potentials. The major products were N₂, nitrate and nitrite (FIG. 5 (c)). The highest FEs of N₂ were observed at low potentials (51% at 1.6 V), and the values decreased slightly with increasing potential (to 34% at 2.2 V). With increasing potential, higher oxidation state products started to dominate with the highest FE of nitrite (28%) observed at 1.6 V (nitrite-to-nitrate ratio of ˜1.5:1). With further increase of the applied potential, the ratio decreased dramatically and the most oxidized product nitrate became dominant at E>1.8 V with FE of up to 60% at 2.2 V. This general trend was in agreement with the reported density functional theory (DFT) results for ammonia electrooxidation on nickel hydroxide surfaces that showed the lowest energy requirements for dinitrogen formation and higher calculated onset potentials for nitrite and nitrate, with that for nitrate being slightly higher than for nitrite. At potentials ranging from 1.8 V to 2.0 V total FE of formed products deviates from 100% (FIG. 5 (c)). These ˜10% FE losses could be attributed to the formation of different side products of nitrite oxidation, such as N^{IV}-containing species, including NO₂ and N₂O₄. While these products were not observed in the reaction headspace by GC, they may exist in aqueous phase where they are not very stable.

To compare the AOR activity of Ni(OH)₂/NF anode to the activity of NF substrate, potentiostatic electrolysis was performed in 0.1 M Na₂SO₄, containing 0.2 M NH₃, at an arbitrary potential of 1.9 V. The average FE of nitrate was ˜30%, and only small amounts of nitrite and N₂ were detected (1% and 5%, respectively). At the same time, the oxygen evolution was the dominant process on this electrode with FE ranging from 40% to 60%. This observation suggests that surface defects abundant in xerogel materials may play a significant role in the AOR reaction selectivity.

The quantitative product analysis was performed on Ni(OH)₂/NF in 0.1 M NaOH. In contrast to the electrolysis in 0.1 M Na₂SO₄, the formation of O₂ was observed at all studied potentials for AOR in 0.1 M NaOH electrolyte (FIG. 5 (g)), where AOR and OER LSV curves overlapped (FIG. 5 (e)). The lowest FE of O₂ (˜9%) was obtained in the electrolysis at 1.6 V. The FE of O₂ noticeably increased at E>1.7 V and remained almost constant with further potential increase (30±3%). These results demonstrated that it is challenging to perform AOR in alkaline media without the OER competition. As for AOR products, N₂, nitrite and nitrate were the major products similar to the electrolysis in 0.1 M Na₂SO₄. The FE of N₂ ranged from 33 to 18% with the highest FE corresponding to the lowest potential. Unlike electrolysis in sulfate, electrolysis in 0.1 M NaOH yielded nitrite as the major product with FE of up to 60% (at 1.6 V vs. RHE), while the FE of nitrate was significantly lower at all potentials studied. Even at 2.2 V vs. RHE a noticeable FE of nitrite (16%) was observed, whereas only nitrate was formed at this potential in 0.1 M Na₂SO₄.

The above results show that AOR selectivity and the competition between AOR and OER are highly dependent on the electrolyte composition. Since these electrolytes differ not only in the nature of their interactions with the electrode surface, but also in pH (13 for NaOH, and ˜11.3 for 0.2 M ammonia in 0.1 M Na₂SO₄), the effect of pH on AOR product selectivity was investigated in more detail to disambiguate these factors (FIG. 5 (d)). To this end, electrolysis over a wider range of pH values were performed in electrolytes containing 0.2 M NH₃/NH₄⁺. Electrolytes with pH 9-12 were prepared using NH₃-containing Na₂SO₄ solution, adjusting pH with the addition of sulfuric acid or sodium hydroxide. For the reactions at pH 13 and 14, 0.1 M NaOH and 1 M NaOH were used as electrolytes, respectively. For all reactions, an arbitrarily applied potential of 1.9 V vs. RHE was used. This series of experiments indicates that the solution pH is responsible for the AOR selectivity: nitrate was the dominant product at pH<12, while nitrite was the major product at pH>12. It was found that the FE of nitrate formation increased with decreasing pH, while the FE of nitrite decreased. In addition, the contribution of OER was observed at pH>12 with the FE of O₂ increasing with pH.

To elucidate the influence of the initial NH₃ concentration on the nitrate/nitrite selectivity, a series of electrolysis were performed with different initial concentrations of NH₃ (0.03-0.2 M) at arbitrary pH and applied potential (11.3 and 1.9 V, respectively). FIG. 5 (h) shows a near-linear relationship between FE of nitrate/nitrite and the initial concentration of ammonia. The FE of nitrate decreased slightly, and FE of nitrite increased almost proportionally with increasing ammonia concentration.

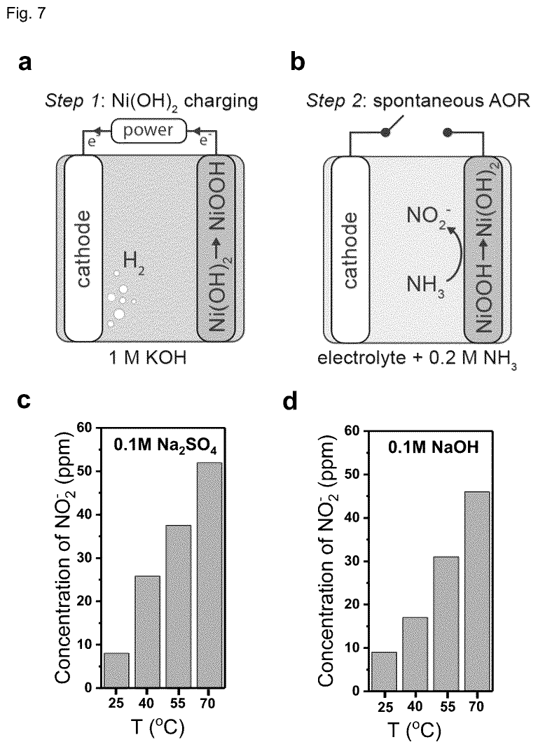

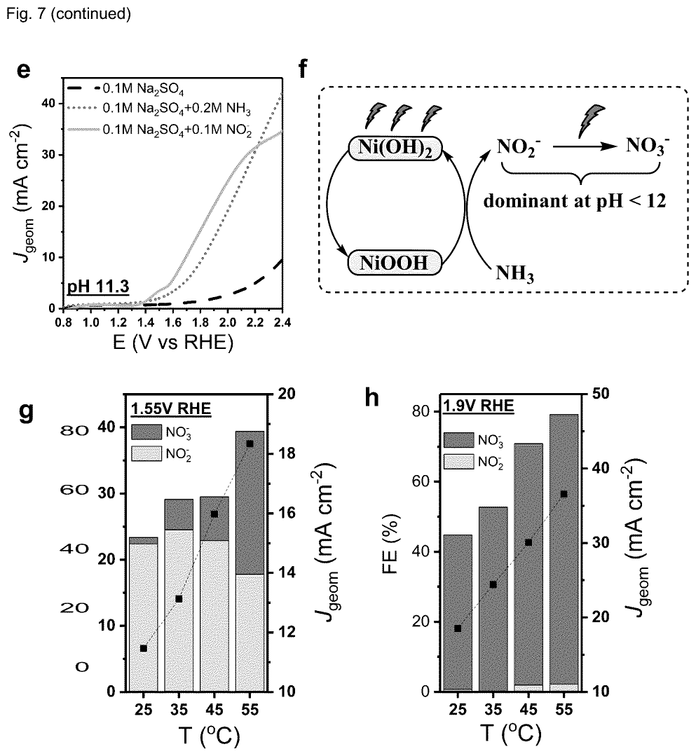

In addition, a series of electrolysis of 0.2 M ammonia were performed at two arbitrary potentials (1.55 V and 1.9 V) and at four different temperatures. In both cases, the current density of AOR increased linearly with the increase of the temperature that is probably associated with the faster turnover of catalytic sites. Nitrite was the main product when the reaction was performed at the very onset potential (1.55 V vs. RHE) and the temperature was between 25-45° C. (FIG. 7 (g)). However, at 55° C. nitrate became the dominant product, indicating that the electrochemical nitrite-to-nitrate step is also temperature-dependent. When the reaction was performed at 1.9 V vs. RHE, an increase of nitrate FE from 45% to 77% was observed with the increase of the temperature from 25 to 55° C. (FIG. 7 (h)). Thus, it was found that the rate of AOR-to-nitrate can be controlled not only by applied potential, but also by the temperature.

Based on the obtained results, it was found that 0.1 M Na₂SO₄ is the preferred choice as the electrolyte for ammonia electrolysis to yield nitrate, while highly alkaline media is required for the efficient conversion of ammonia into nitrite. For the synthesis of ammonia-based fertilizers AOR to nitrate is the reaction of interest. Therefore, further studies for preparative ammonia electrolysis were conducted with sulfate electrolyte.

Preparative Electrolysis

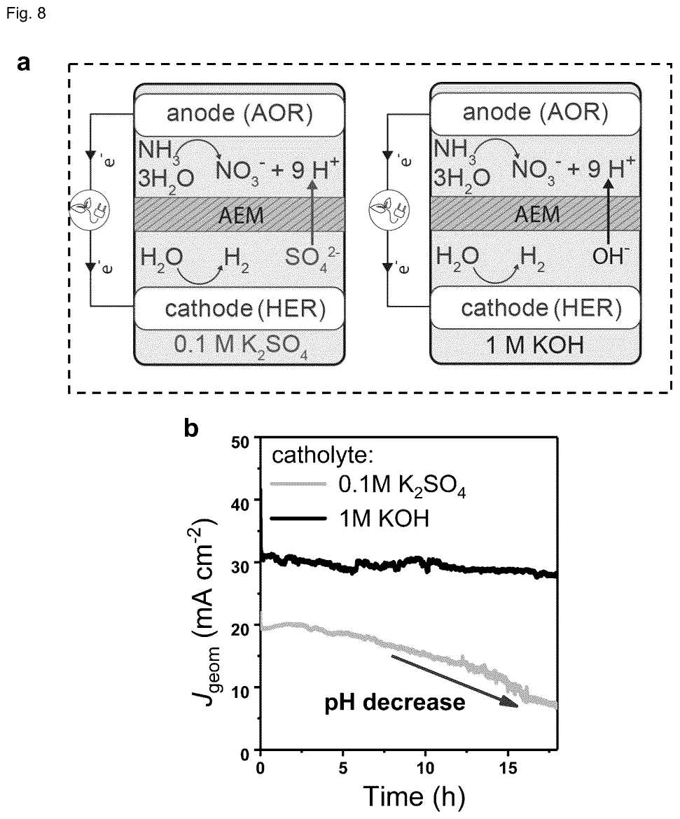

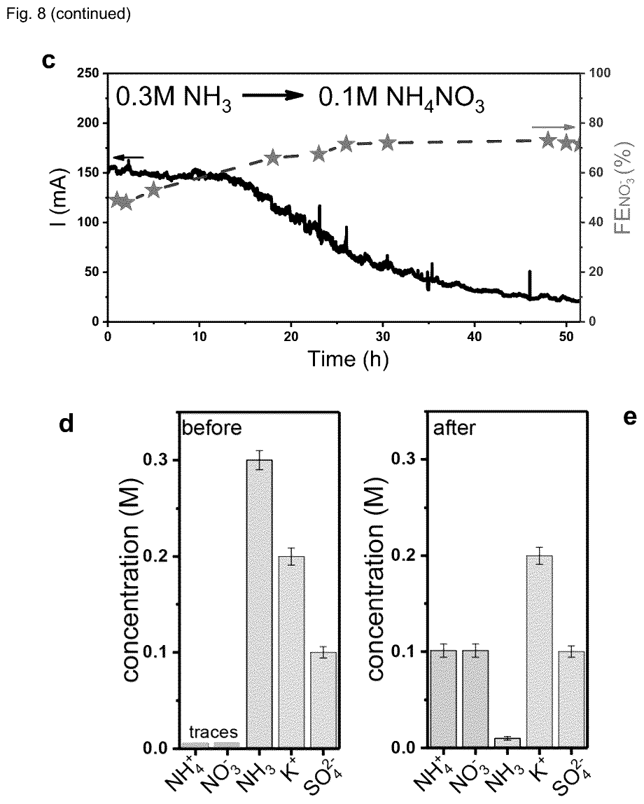

To evaluate the synthetic potential of the AOR-to-nitrate approach, scaled-up electrolysis was performed until reaching the full conversion of ammonia (FIG. 8). Preparative AOR was performed in a divided cell with 150 ml compartments equipped with a peristaltic pump circulating the electrolyte at a constant electrolyte flow rate of 50 ml min⁻¹.

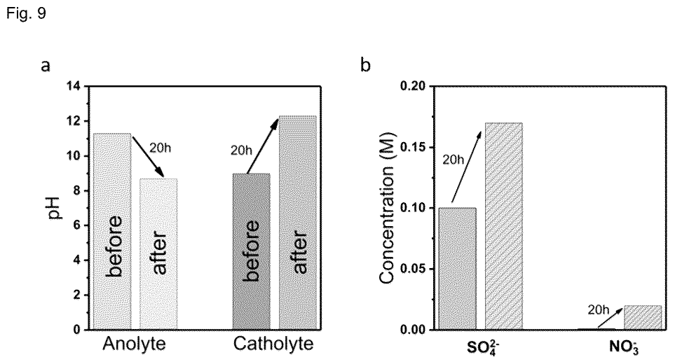

First, electrolysis of 0.2 M NH₃ was performed using a 1.5 cm² Ni(OH)₂/NF anode, and 0.1 M K₂SO₄ as an electrolyte in both the cathodic and anodic compartments. The current diminished after 0.5 mol of electrons was transferred per mol of NH₃ indicating a significant drop of AOR activity, despite the fact that 4 mol of electrons per mol of NH₃ is theoretically required for the full conversion of NH₃ into NH₄NO₃ (FIG. 8 (a) and FIG. (b)). While not wishing to be bound by theory, it was hypothesized that this dramatic change in AOR activity could be attributed to the acidification of the anolyte. Indeed, the measured pH of the anolyte after the electrolysis was 8.7, indicating that the remaining ammonia was predominantly protonated (FIG. 6) and, therefore, not electrochemically active. In addition to the pH change, an increase of SO₄²⁻ concentration in the anolyte was observed, which was proportional to the charge passed since SO₄²⁻ anions were dominant charge carriers in the catholyte that were able to cross AEM in a course of electrolysis (FIG. 9).

To address the issue of gradual anolyte acidification during the reaction progression and maximize the conversion of ammonia in the preparative electrolysis, 0.1 M K₂SO₄ was replaced with 1 M KOH in the cathodic compartment, while still using 0.1 M K₂SO₄ in the anodic compartment. The purpose of this replacement was to compensate the excess protons formed in the anodic compartment in the course of ammonia oxidation with OH⁻ passing through the AEM from the cathodic compartment, thereby maintaining the pH of the anolyte in the course of electrolysis. The potentiostatic electrolysis in the resultant system proceeded with no changes in AOR current density even after transferring 1.2 mol of electrons per mol of NH₃ and the anolyte pH remained almost constant in a course of 20 h of electrolysis. The current began to decline only after 1.6 mol of electrons per mol of NH₃, which was associated with a significant decrease 27 in the ammonia concentration and not with anolyte acidification. Thus, using a combination of an alkaline catholyte and 0.1 M K₂SO₄ anolyte was found to improve the preparative electrolysis of ammonia.

In a further embodiment electrolysis of 0.3 M NH₃ in 0.1 M K₂SO₄ anolyte was conducted while using an alkaline catholyte and monitoring the concentration of formed nitrate by IC (FIG. 8 (c)). For this experiment, a 5 cm² Ni(OH)₂/NF anode was used to increase the rate of ammonia conversion. The current was stable in the first 12.5 h of the electrolysis, which corresponded to 1.6 mol of electrons per mol of NH₃. During this period, the total FE of nitrate rose from 50% to 66%, which can be associated with the ammonia depletion combined with a higher FE of nitrate at lower ammonia concentrations (FIG. 5d). An exponential decay in current was observed after 12.5 h, which then substantially dropped and plateaued after 3.7 mol of π electrons per mol of NH₃ was transferred (52 h). The total FE of nitrate at the end of electrolysis was 72%, and the concentration of NH₄NO₃ was ˜0.1 M (FIG. 8e). The remaining current went into the formation of N₂, which was evident by the constant formation of bubbles at the anode surface in a course of electrolysis. In addition, IC analysis revealed that 97% of ammonia was removed from the solution after electrolysis (FIG. 8e). Thus, it was demonstrated that 0.3 M NH₃ can be oxidized in the 0.1 M K₂SO₄ electrolyte at Ni(OH)₂/NF anode to form nitrogen gas and 0.1 M NH₄NO₃ solution. The resulting solution corresponded to a fertilizer with the N—P—K—(S) ratio of 11-0-37-(13).

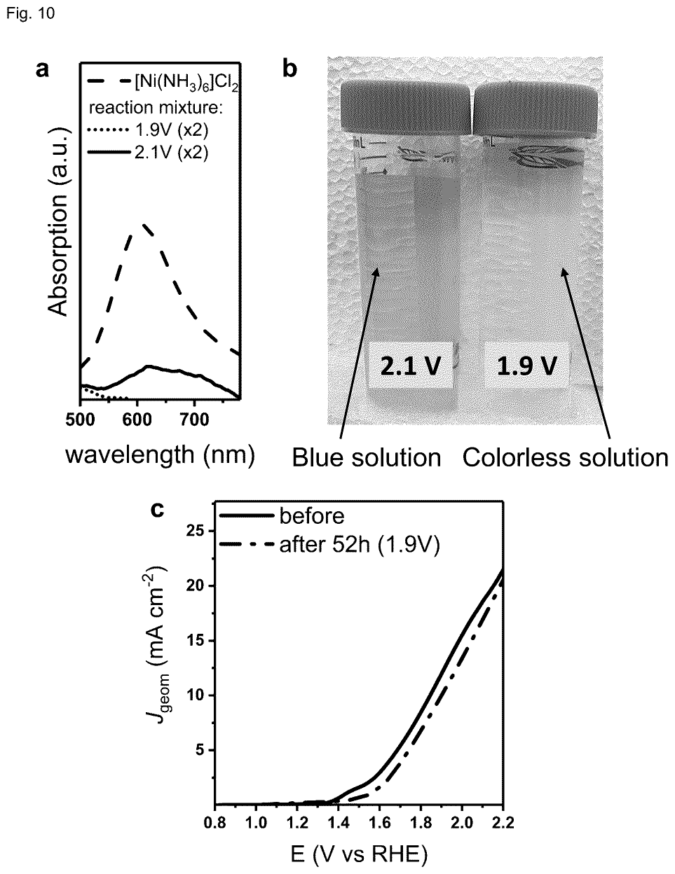

The catalyst stability during long-term electrolysis was estimated by comparing LSV curves for 0.2 M NH₃ in 0.1 M Na₂SO₄ before and after the electrolysis. A decrease of approximately 15% in catalyst activity was observed after 52 h of operation, indicating some catalyst degradation or passivation in a course of electrolysis. To further investigate the catalyst stability, a long-term electrolysis experiment was performed at a more positive potential (27 h at 2.1 V vs. RHE). Under these conditions, despite the good FE of nitrate (72.5%), a significant degradation of the catalyst was visually observed. Moreover, the colour of the reaction mixture became blue, indicating the presence of [Ni (NH₃)₆]²⁺ species in the solution. To confirm this hypothesis, absorption spectra of the reaction mixtures after the preparative electrolysis at 1.9 V and 2.1 V were compared to the reference solution of [Ni(NH₃)₆]Cl₂ (FIG. 10). In the case of electrolysis at 2.1 V, a peak at ˜650 nm was observed, similar to the peak of [Ni(NH₃)₆]Cl₂. No peak in this area was observed for the reaction mixture after the electrolysis at 1.9 V, indicating that at this voltage the anode remains stable, while at higher voltages it slowly dissolves.

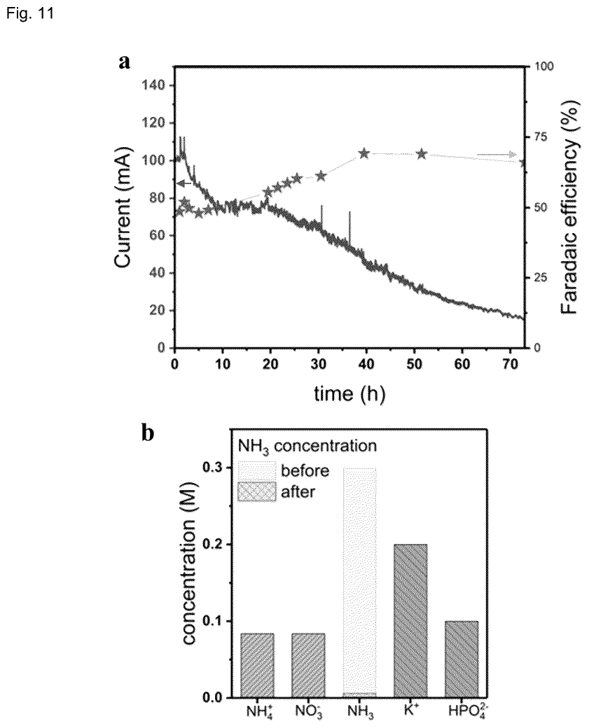

In another embodiment, in order to minimize the sulfur content in electrochemically synthesized fertilizer and introduce another important element namely phosphorus, K₂SO₄ was replaced by a P-containing electrolyte, specifically, 0.1 M K₂HPO₄. K₂HPO₄ was chosen as an electrolyte since its mixture with 0.3 M ammonia has pH ˜11 and nitrate will be the major product, while the mixture of K₃PO 4 and 0.3 M ammonia has pH>12 and nitrite would be the main AOR product. The preparative electrolysis of ammonia in 0.1 M K₂HPO₄ solution was conducted using a 5 cm² Ni(OH)₂₋/NF anode (FIG. 11). The currents were ˜1.5 times smaller than that observed for K₂SO₄, which can be associated with the difference in the conductivities of the two electrolytes. The electrolysis was stopped after 72 h, where the total mol of electrons transferred was 3.3 per mol of NH₃. The FE of nitrate was slightly smaller than that observed in the electrolysis in 0.1 M K₂SO₄ and rose from 48% in the beginning of the electrolysis to 66% at the end, and 98% removal of ammonia was confirmed by IC (FIG. 11). IC analysis of the resulting solution showed that it consisted of 0.85 M NH₄NO₃ and 0.1 M K₂HPO₄, which corresponded to a fertilizer N—P—K—(S) ratio of 10-42-39-(0).

Electrochemical ammonia oxidation (AOR) coupled with CO₂ electroreduction to CO

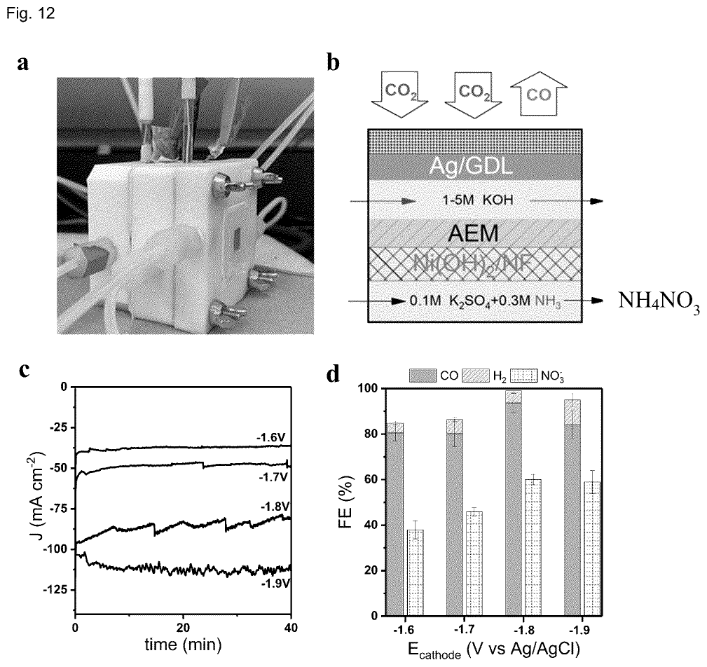

The replacement of oxygen evolution reaction (OER) with ammonia oxidation reaction in CO₂ electrolyzers is a promising strategy for simultaneous carbon and nitrogen footprint mitigation. In a further aspect, the present inventors have shown that ammonia conversion to ammonium nitrate can be coupled with CO₂ reduction reaction (CO₂RR) to CO in a flow electrolyzer equipped with Ag gas-diffusion electrode (Ag/GDL). FIG. 12 (a) and FIG. 12 (b) demonstrate the electrolyzer used for paired electrolysis, consisting of three chambers (CO₂ flow channel, catholyte, and anolyte), two reference electrodes, anion exchange membrane, Ag/GDL cathode and nickel foam-supported Ni(OH)₂ xerogel anode. This system configuration with two reference electrodes allows for monitoring of potentials on both sides of the cell (on the anode and on the cathode) to maintain the cell operation within the potentials outside of the catalyst degradation regions. Alternatively, the cell can be operated in a two-electrode configuration with only cell voltage being controlled, provided that the electrode surface areas are optimized to maintain the appropriate (i.e., outside of degradation region) anodic voltage when a certain cell voltage is applied.

To evaluate the influence of the applied potential on the AOR and CO₂RR product distribution, a series of potentiostatic electrolysis was performed. All reactions were performed with alkaline catholyte, which was found to be the best media for CO₂RR in flow systems with gas-diffusion electrodes. Since higher CO₂RR current densities can be achieved in 5 M KOH (FIG. 12 (c)), it was used for potentiostatic electrolysis. The anolyte was 0.1 M K₂SO₄, containing 0.3 M ammonia. CO₂R products were analyzed by gas chromatography (GC), and AOR products were analyzed by ion chromatography (IC). It was found that at all potentials tested, FE of CO was >80%, reaching the maxima (˜94%) at −1.8 V vs Ag/AgCl. In agreement with our data for [HER|AOR] electrolyzer, an increase in nitrate FE of nitrate was observed with increasing potential (FIG. 12 (d)). As a result, when −1.8 V was applied to the cathode, paired electrolysis led to the simultaneous production of CO and nitrate with FE of 94% and 60%, respectively. Comparable results were obtained at −1.9V in terms of FEs, while higher currents were achieved (above 100 mA/cm²); further cell configuration improvement (decreasing the distance between the electrodes and the membrane) lead to the current density increase to near 200 mA/cm², indicating that large-scale electrolysis can be performed at industrially relevant currents. Similar results were obtained when K₂SO₄ electrolyte was replaced with K₂HPO₄, which enables altering the N:P:K(:S) ratio of the final fertilizer.

Effect of Catalyst Composition on the AOR Performance

The inventors have found that various Ni-hydroxide-based catalysts are suitable for the described process. In terms of the metal composition, it has been found that using Ni(OH)₂ doped with Fe, Co, Cu, or Mn as anodic electrocatalysts resulted in conversion of ammonia to ammonium nitrate in appreciable amounts comparable or higher than those obtained in the absence of doping. Secondary metal doping in the 10-20% range (atomic, i.e., 1:9-1:4 Me:Ni, where Me is a secondary metal) resulted in the highest nitrate yield; among the studied metals, Fe doping showed the best selectivity towards nitrate, with no nitrite formation even under the potentials at which nitrite formation was observed when an undoped Ni(OH)₂ was used. The selectivity of the doped materials towards nitrite slightly decreased in the raw Ni_{0.8}Fe_{0.2}(OH)₂, Ni_{0.8}Cu_{0.2}(OH)₂, Ni(OH)₂, Ni_{0.8}Mn_{0.2}(OH)₂, Ni_{0.8}Co_{0.2}(OH)₂. In terms of the catalyst efficiency, for example, in the raw of the materials with 20% secondary metal the highest current density at the same potential (1.9V vs RHE) was achieved for Ni_{0.8}Co_{0.2}(OH)₂, followed by Ni_{0.8}Mn_{0.2}(OH)₂, Ni_{0.8}Co_{0.2}(OH)₂, Ni_{0.8}Fe_{0.2}(OH)₂. In terms of the electrocatalyst support, it was found that nickel foam is a superior substrate for depositing the hydroxide material compared to copper foam, carbon felt, carbon paper or carbon cloth, with current densities at least two-fold higher while preserving high nitrate selectivity (in the case of copper foam, the currents were comparable to those obtained on nickel foam, but the selectivity towards nitrate decreased); furthermore, the nickel foam supported electrocatalysts were stable at least over the course several days of electrolysis, whereas carbon supports slowly degraded over time. At the same time, it was found that integrating small fractions of carbon black and Nafion into the electrocatalyst ink prior to the deposition on nickel foam improved the conductivity of the resulting electrocatalyst while enabling it to maintain long-term stability. In terms of micro- and nanostructure of the nickel foam support, it was found that increasing the surface area of the foam via electrodeposition of rough sub-micron Ni(OH)₂ layers (with micro- and nanoscale spikes) led to 2-3-fold increased current densities.

Spontaneous Oxidation

The present inventors have found that an electrogenerated NiOOH surface can spontaneously oxidize ammonia. The inventors have designed experiments to elucidate the mechanism of the spontaneous non-electrochemical pathway to better understand the AOR mechanism at Ni(OH)₂ catalyst.

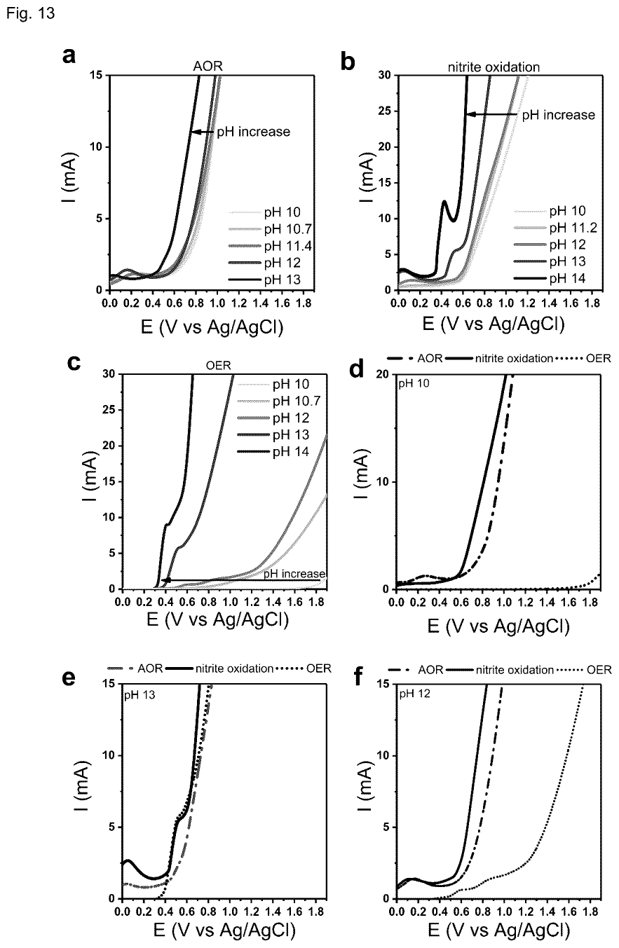

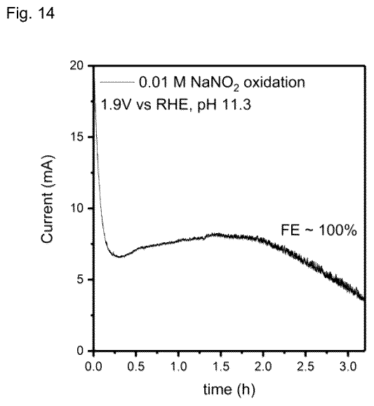

In the experiment, a constant current of 50 mA cm⁻² was passed through Ni(OH)₂/NF anode in an undivided cell containing 1 M KOH for 20 minutes to charge the electrode, i.e., to oxidize Ni(OH)₂ to NiOOH. The charged electrode was then removed from the electrochemical cell and immersed in the 0.1 M Na₂SO₄ or 0.1 M NaOH solution containing 0.2 M NH₃ for 10 minutes (FIG. 7). The reactions were performed at different temperatures, and the products were analyzed by IC (FIGS. 7c and d). For both solutions, only the formation of nitrite was observed at all temperatures and the formation rate was found to be temperature-dependent. To understand whether nitrite can be spontaneously oxidized to nitrate at NiOOH surface, the same experiment was performed in 0.1 M Na₂SO₄ containing ˜2 mM nitrite. However, the formation of nitrate from nitrite even after 30 min at 70° C. was not observed. Thus, one can expect nitrite that formed via the spontaneous oxidation of ammonia by NiOOH immediately undergoes the electrooxidation to nitrate, which is only achievable when the voltage is applied. To validate this hypothesis, LSV was performed for nitrite oxidation in 0.1 M Na₂SO₄ and compared the data to that for the electrochemical AOR and OER at different pH (FIG. 7 and FIG. 13). Based on the LSV data at pH<12, both AOR and nitrite oxidation proceeded at significantly lower potentials than OER, with nitrite having a slightly lower onset potential than AOR. Then electrolysis of 0.1 M Na₂SO₄ containing 10 mM NaNO₂ was conducted at Ni(OH)₂ anode at 1.9 V and pH of 11.3 (FIG. 14), and quantitative conversion of nitrite to nitrate was indeed observed (FE of nitrate ˜100%). These experimental results taken together suggest that AOR to nitrate proceeds via the following steps: (1) electrochemical oxidation and deprotonation of Ni(OH)₂ to NiOOH, (2) non-electrochemical NH₃ oxidation to nitrite by NiOOH, and (3) electrochemical oxidation of nitrite to nitrate. A similar behavior of NiOOH was found when ammonia was replaced with another abundant N-containing waste—urea.

On the basis of spontaneous and vigorous oxidation of urea or ammonia in the absence of applied potential on NiOOH and metal-doped NiOOH, an alternative approach to membrane-free electrolyzer operation has been developed, which does not require an additional heating step and simultaneously provides a solution to nitrogenous wastewater treatment. Specifically, such an electrolyzer operates in the following two steps. First, during the electrochemical operation step, while voltage is applied, hydrogen formation or CO₂ electroreduction takes place at the cathode, while Ni(OH)₂ (or a doped analogue, NᵢₓM₁₋ₓ(OH)₂ where dopants include M=Cr, Mn, Fe, Co, Cu, Zn, W, or Mo) anode transitions to its oxidized form NiOOH (or a doped analogue, NᵢₓM₁₋ₓOOH). Second, during the chemical operation step, no voltage is applied, and a solution of ammonia or urea in deionized water or water containing sodium or potassium sulfate or hydroxide is introduced to the anode; during this step, NiₓM₁₋ₓOOH transitions spontaneously back to the reduced form NiₓM₁₋ₓ(OH)₂, while urea or ammonia undergoes oxidation to nitrogen gas, nitrite, and/or nitrate (the ratio of which depends on the material composition, i.e., the presence of dopants, as well as the pH and concentration of the urea/ammonia solution). Upon the full reduction of NiₓM₁₋ₓOOH material to NiₓM₁₋ₓ(OH)₂, the reaction stops, and the system returns to the electrochemical step, and so forth (i.e., the reactor operates in the swing mode alternating between the two steps; in principle, the reactor can operate with a membrane as well, however, when operating in swing mode, the membrane is not necessary). Importantly, the rate of the anode material reduction in urea is an order of magnitude higher at ambient conditions than that in ammonia (note that in water without urea or ammonia this process does not occur at ambient conditions), suggesting that urea solutions are suitable discharge medium for swing electrolyzers at ambient conditions.

Anodes for this process are made of Ni-based materials obtained either via electrodeposition or colloidal synthesis and can be doped with secondary metals, such as Co, Cu. In the electrochemical charging step, the oxidation state of the anode changes without producing any molecular species, while water or CO₂ are reduced at the cathode to hydrogen gas or to syngas/other carbon-based products, respectively. The step requires potassium hydroxide electrolyte with pH≥14 and applying of constant current density until potential reaches the oxygen evolution onset potential. In the non-electrochemical discharge step, the material of the anode is being chemically regenerated to its initial state, simultaneously catalyzing ammonia or urea oxidation. The step involves introducing ammonia or urea in potassium sulphate or dipotassium hydrogenphosphate solution or in deionized water, electrooxidizing ammonia or urea into ammonium nitrite, nitrate or nitrogen gas on the surface of a charged anode. The overall process requires an electrochemical cell, equipped with a cathode, electrolyte channel, and the redox anode. For CO₂ reduction, a gas diffusion electrode and a CO₂ flow channel are also required. In the charge mode, the cell is operated as an electrochemical cell, while in the discharge mode no voltage is applied, and the liquid channel is flushed with discharging ammonia-containing solution, and then the cell switches to the charge mode, and steps are repeated.

In the spontaneous swing mode electrolyzer system and method, no membrane is necessary and a single channel introducing the solution can be used. The electrolyte solution and urea/ammonia solution flow through the cell which is switched between the first and second step of the swing mode operation.

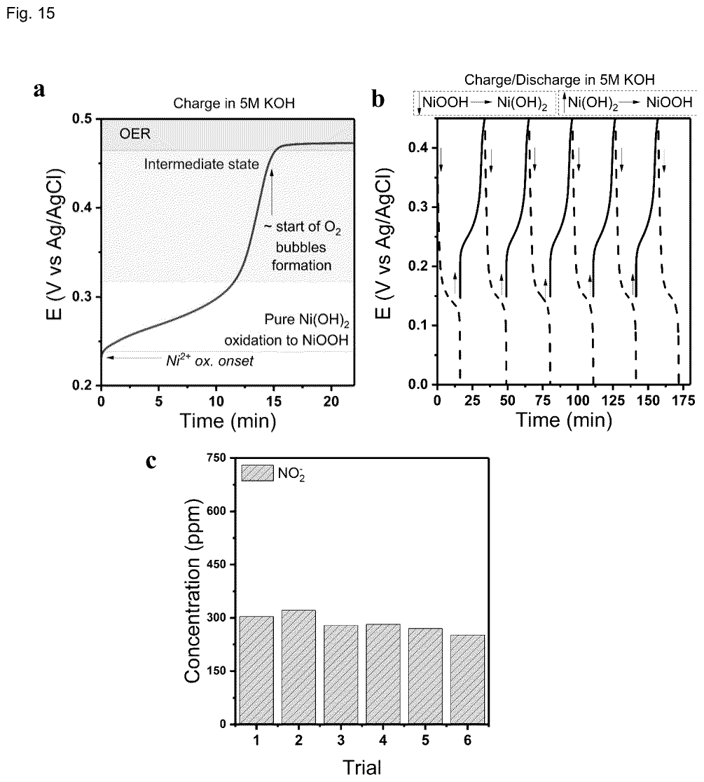

In one example an anode of Ni_{0.9}Co_{0.1}(OH)₂ was made by electrodeposition of Ni and Co onto Ni foam support at 70° C. followed by electrochemical activation (260 C cm⁻² charge was passed for deposition). The charge capacity of the material is up to 50 C cm⁻². FIGS. 15 (a) and 15 (b) depict charging and discharging of the Ni_{0.9}Co_{0.1}(OH)₂ anode in 5 M KOH at 50 mA cm⁻², indicating a good stability of the electrode The results of chemical discharge in 0.33 M urea and 0.1 M NaOH of electrogenerated Ni_{0.9}Co_{0.1}OOH show good reproducibility as depicted in FIG. 15(c).

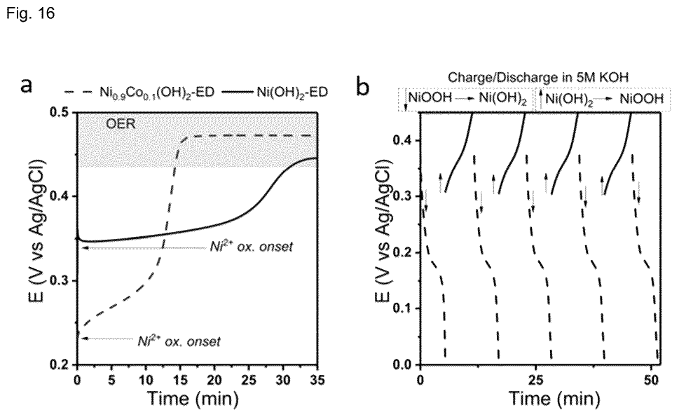

In another example an undoped Ni(OH)₂ anode was made by electrodeposition of Ni onto Ni foam at 70° C. followed by electrochemical activation (260 C cm⁻² charge was passed for deposition). The charge capacity of the material is up to 70 C cm⁻². FIGS. 16(a) and 16(b) depict charging and discharging of the Ni(OH)₂ anode compared to Ni_{0.9}Co_{0.1}(OH)₂ anodes in 5 M KOH at 50 mA cm⁻². Ni(OH)₂ showed higher potentials required for the electrochemical charging compared to Ni_{0.9}Co_{0.1}(OH)₂. The electrode also showed good stability in electrochemical charging/discharging steps.

A study of the effect of temperature on spontaneous urea oxidation reaction (UOR) over NiOOH was conducted afterwards. Specifically, the electrochemically generated NiOOH anode was placed into a scintillation vial, containing 15 ml of 0.33 M urea solution in 0.1 M KOH.

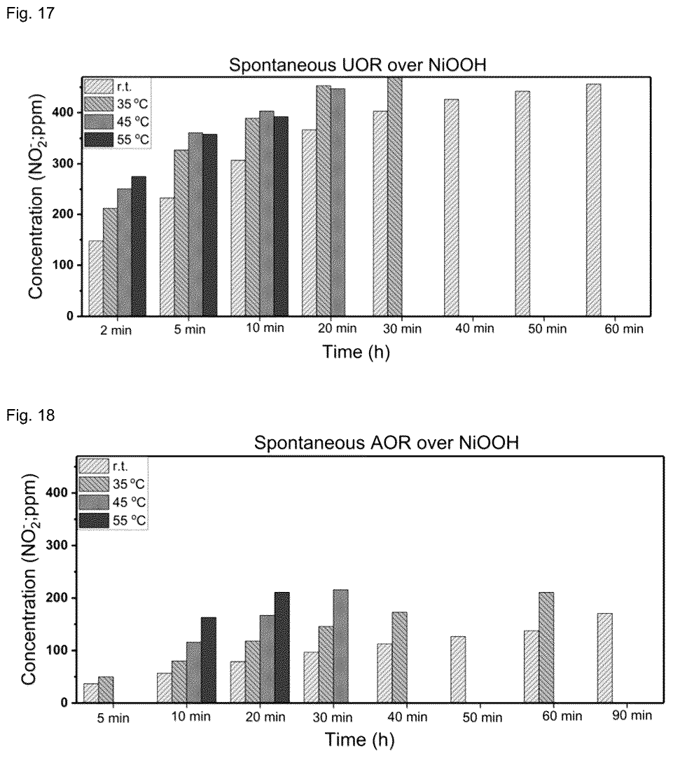

The chemical discharge was performed at different temperatures with vigorous stirring to ensure good mass transfer. The concentration of NO₂ was measured over time. The results are shown in FIG. 17. The highest values of concentration (˜400 ppm) correspond to complete discharge of the electrode. After most NiOOH is reduced, UOR starts to proceed slowly, for instance, there are almost no changes after 30 minutes of UOR at r.t. A study of the effect of temperature on spontaneous ammonia oxidation reaction (AOR) over NiOOH was also undertaken. The results are shown in FIG. 18, which indicate that the reaction with ammonia proceeds slower compared to urea, and complete discharge of the electrodes was not achieved even after 1.5 h.

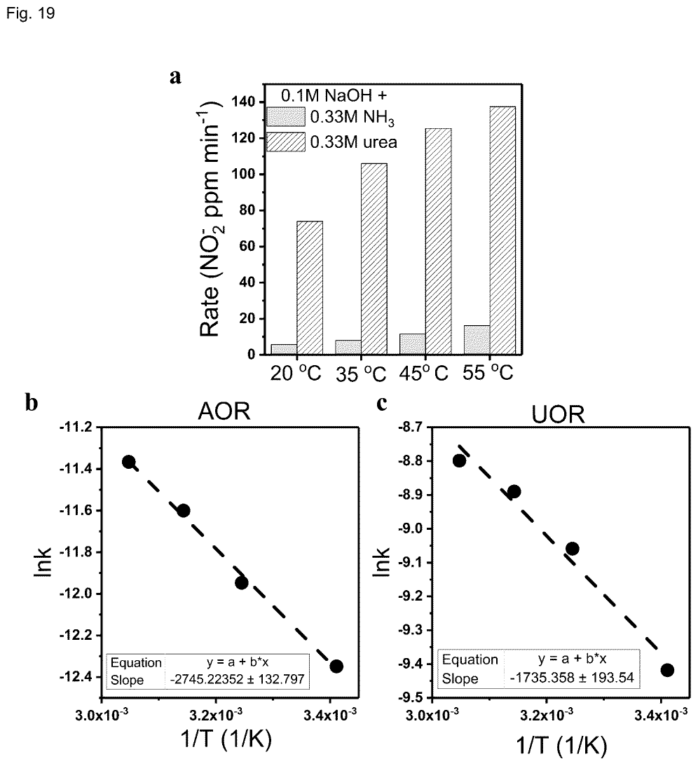

A comparison of the rate of nitrite production for ammonia oxidation reaction (AOR) vs urea oxidation reaction (UOR) on electrogenerated NiOOH was undertaken and the results are shown in FIG. 19. The reaction rate of UOR was found to be ˜10 times higher than that for AOR. For E a estimation, units of rates (FIG. 19 (a)) were converted to M 5-1. Rate constants were obtained as: k=d[NO₂⁻]/[urea]*dt (s⁻¹). The slope of In k (1/T) function is—Eₐ/R, where R=8.31 J K⁻¹ mol⁻¹. Eₐ(UOR) was calculated as 209±23 J/mol; and E a (AOR) was calculated as 330±16 J/mol. It appears that for OER activation energy will be much higher (in kJ mol⁻¹) since reaction does not occur at low temperatures in 0.1 M KOH and requires high temperatures (up to 95° C.).

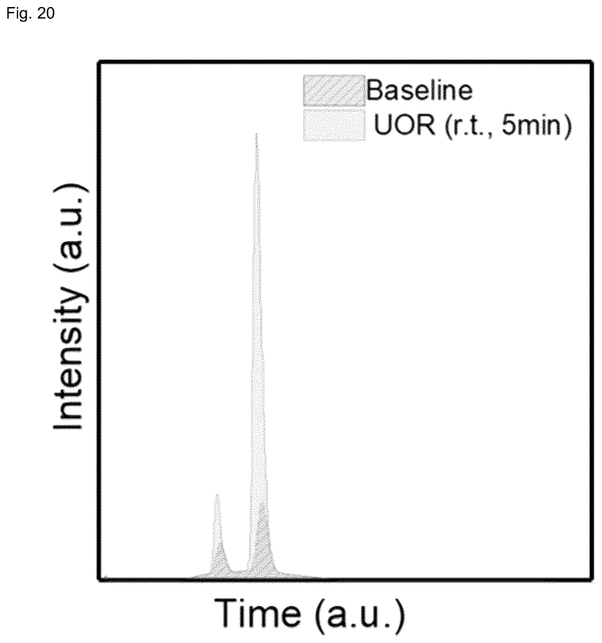

The effect of spontaneous AOR/UOR on electrogenerated N₂ formation was studied using 0.1 M NaOH and 0.33 M urea. The selectivity was estimated based on the amount of nitrite and N₂ produced (FE_{N2}˜37%; FEₙᵢₜᵣᵢₜₑ ˜60%) for UOR. The inventors have found that N₂ selectivity goes up with increasing concentration of urea. FIG. 20 is an example of a gas chromatogram (GC) obtained after spontaneous UOR. The GC shows that N₂ is the primary gas product. (A small change in O₂ concentration also appears which is due to small leakage during sampling and injection of the sample into the GC process.) OER in 0.1M NaOH was not observed at r.t. since a higher temperature is required.

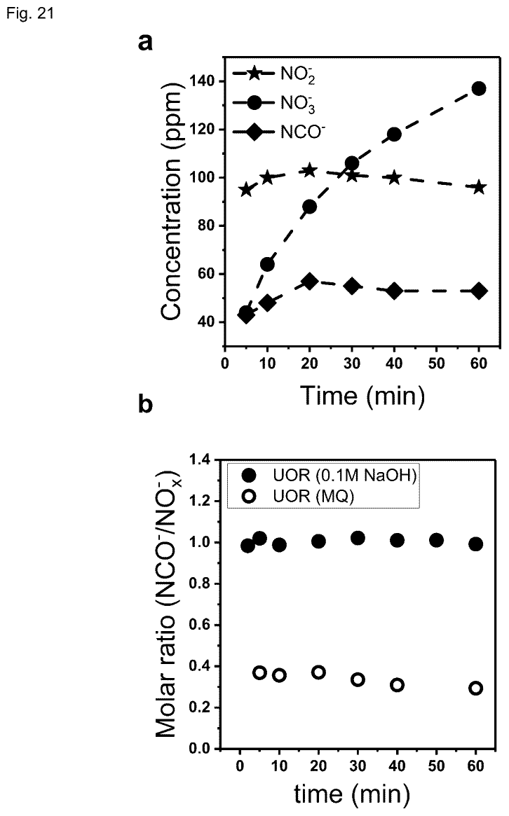

The present inventors have found that spontaneous processes (UOR, AOR, and OER) are pH-dependent. Spontaneous UOR in neutral condition in Milli-Q (MQ) water at 35° C. was studied and was found to undergo formation of nitrate unlike UOR in alkaline media (FIG. 21). It is noted that urea in MQ water has a pH of approximately 7.8. In addition, the ratio of cyanate (secondary product of UOR) to NOₓ⁻ is around ˜0.3 in MQ water, while in alkaline media it is around 1:1. These results suggest that in MQ water, cyanate undergoes oxidation. This is likely due to the absence of anions in the solution that can replace formed NCO⁻ ion on the surface. (In alkaline media fast desorption is happening, when OH⁻ replaces CNO⁻ at Ni site). For AOR this reaction does not proceed at a perceptible rate since the pH of NH₃ in MQ is alkaline (pH>11).

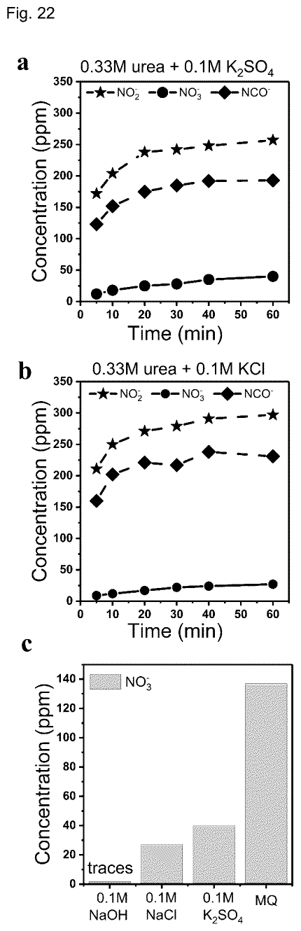

Spontaneous UOR in 0.1 K₂SO₄ and 0.1 NaCl in neutral media at 35° C. was studied (FIG. 22). It was found that similar to the reaction in MQ water, UOR in sulfate and chloride proceeds with the formation of nitrate, but in smaller amount. From this result it seems that the better the coordination of anion to Ni site, the lower nitrate content. In MQ water reaction occurs readily since almost no ions are present in the solution, and oxidation of cyanate is dominant over its desorption. While not wishing to be bound by theory it is thought that this could also be the reason why spontaneous AOR does not produce nitrate, as adsorption of OH⁻ or/and ammonia dominates over adsorption of nitrite.

UOR in 0.1M KCl was also studied but the solution became cloudy therefore Cl⁻ is not recommended in the discharge solution. Further investigation is required to understand why this occurs.

In summary, the present inventors have demonstrated how the product distribution in Ni(OH)₂-catalyzed electrochemical oxidation of ammonia depends on a variety of operating parameters, including the electrolyte nature and its pH, applied potential, concentration of ammonia, and reaction temperature. The inventors have found that ammonia electrolysis in neutral electrolytes (e.g., Na₂SO₄) proceeds without competing OER and yields N₂ and nitrate as major products at E>1.7 V vs. RHE, nitrite is formed in noticeable amounts only at the very onset of the oxidation wave. The inventors have found that the ammonia-to-nitrogen pathway is dominant at low applied potential, while the ammonia-to-nitrate pathway contribution increases with increasing potential. The rate of AOR in neutral electrolytes and FE of nitrate increase with increasing temperature, which is associated with the faster turnover of the catalytic sites at elevated temperatures. Also, the FE of nitrate increases with decreasing concentration of ammonia. In contrast to the electrolysis in neutral electrolytes, AOR in alkaline electrolytes (e.g., NaOH) is accompanied by OER at all studied potentials, and nitrite becomes the major product of AOR. The formation of nitrate in alkaline electrolytes proceeds slowly, and it becomes a major AOR product only at E>2.1 V vs. RHE. The difference between the product distribution in these two electrolytes is associated with their different pH. The FE of nitrate formation increases with decreasing pH, while the FE of nitrite decreases. The switch between nitrate/nitrite selectivity happens at pH˜12. A noticeable contribution of competing OER is observed at pH>12, and the FE of O₂ increases with increasing pH, which is associated with the higher availability of OH⁻ species. The inventors have demonstrated that the ammonia-to-nitrite pathway can proceed spontaneously (without applied potential) on pre-electrogenerated NiOOH, while nitrite-to-nitrate transformation is an electrochemical step requiring applied potential. Based on these results, it is proposed that AOR to nitrate proceeds via the sequential electrooxidative deprotonation of Ni(OH)₂, non-electrochemical NH₃ oxidation to nitrite by NiOOH, and electrochemical oxidation of nitrite to nitrate. The ability of Ni(OH)₂ catalyst to selectively oxidize ammonia into nitrate can be used to produce a recycled fertilizer: specifically, electrolysis of NH₃-containing solutions of Na₂SO₄ or K₂HPO₄ can be converted into solutions of PKNS and PKN fertilizers. The inventors have demonstrated that preparative electrolysis of 0.3 M ammonia in these two electrolytes produces NH₄NO₃/K₂SO₄ and NH₄NO₃/K₂HPO₄ fertilizers with molar ratios of 1:1 and 1:0.85, respectively. This approach can be used for the continuous electrochemical synthesis of N-fertilizers, which can be integrated into the systems for the anaerobic digestion of N-containing waste.

### Examples

Preparation of Ni(OH)₂/NF Anode:

Ink preparation: Nanostructured Ni(OH)₂ catalyst was prepared using the optimized epoxide solgel synthesis method Catalyst inks were made in a 15-ml glass vial by mixing of 120 mg of Ni(OH)₂ catalyst with 60 mg Vulcan Carbon Black (FuelCellStore) followed by the addition of 7 mL of absolute ethanol (>99.9% ACS grade, Sigma-Aldrich). The mixture was sonicated for a few seconds to disperse the powder in the solvent. Solution containing 0.6 mL of Nafion-117 solution (˜5% in a mixture of lower aliphatic alcohols and water, SigmaAldrich) was added to the dispersed solution afterwards. Ink mixtures were then sonicated for 1 h at 60° C. in a closed vial.

Substrate preparation: Ni foam (1.6 mm thickness, MTI Corporation) was cut into several pieces with dimensions of 1 cm×3 cm (width and length, respectively) for the standard electrode, and with dimensions of 1 cm×6 cm for the electrode used in the preparative ammonia electrolysis. Nickel foam pieces were cleaned by successive sonication in acetone and water for 15 minutes, and then dried under Ar flow.

Anode preparation: Freshly cleaned Ni foam was immersed in the ink solution and sonicated for 10-15 minutes, pulled out and dried. Then the ink was dropcasted evenly onto both sides of the foam. The total volume of the ink deposited was adjusted to ˜10 mg cm−2 of Ni(OH)₂ catalyst on each electrode. The as-prepared electrodes are shown in FIG. 2.

Electrochemical Cell Setup:

Cyclic voltammetry and chronoamperometry studies were conducted in a conventional gas-tight two-compartment cell (the volume of each compartment was 150 mL), equipped with an anion exchange (Fumasep FAB-PK-130, FuelCellStore), Ni(OH)₂/NF anode, NF cathode, and Ag/AgCl double-junction reference electrode and connected to an electrochemical workstation (Biologic SP-300). All recorded potentials (vs Ag/AgCl) were converted to the reversible hydrogen electrode (RHE) scale using the Nernst equation: ERHE=EAg/AgCl+Eo Ag/AgCl+0.059×pH, where Eo Ag/AgCl=0.1976 at 25° C., and pH of the anolyte was measured using PH60 pH meter (APERA Instruments). All potentials are reported as measured, without Ohmic potential drop corrections. Ag/AgCl reference electrode was calibrated using 10 mM ferro-ferricyanide system in 0.5 M H₂SO₄, and the obtained ox-red potentials agreed with those reported in the literature.

0.1 M Na₂SO₄ (99%, ACP Chemicals) or 0.1 M NaOH (>97%, Sigma-Aldrich) solutions in MilliQ water was used as catholyte and anolyte (the volume of the electrolyte in each compartment was 65 ml). NH₃-containing anolyte was prepared by the dilution of the concentrated solution of NH₃ (ACS reagent, 28-30% NH₃ basis, Sigma-Aldrich), the ammonia content in which was determined by ion chromatography (IC) using Metrohm Eco IC equipped with a cation column using 1.7 mM HNO₃ (ACS reagent, 70%, Sigma-Aldrich)+1.7 mM 2,6-pyridinedicarboxylic acid (99%, SigmaAldrich) solution in Milli-Q water as an eluent. The calibration curve standards, containing 1-10 ppm NH₄+ were prepared from NH₄F (>99.99%, Sigma-Aldrich).

Preparative Electrolysis:

Preparative AOR was performed in a 150 ml divided cell equipped with inlet and outlet for the electrolyte circulation, 5 cm² Ni(OH)₂/NF anode, NF cathode, and Ag/AgCl single-junction reference electrode and connected to an electrochemical workstation (Biologic SP-50). 0.1 M K₂SO₄ (>99%, Sigma-Aldrich) or 0.1 M K₂HPO₄ (>98%, Sigma-Aldrich) with 0.2-0.3 M NH₃ solutions were used as an anolyte. 0.1 M K₂SO₄ or 1 M KOH (>85%, ACS reagent, Sigma-Aldrich) solutions were used as a catholyte. The volume of the electrolyte in each compartment was 145 ml, the flow rate of the electrolyte was 50 ml min 1. Unless otherwise stated, electrolysis was stopped when current became low, and the total charge passed was close to the charge theoretically required for the full conversion of ammonia.

Product Analysis:

In a course of potentiostatic electrolysis, Ar (99.999%, Praxair) was continuously bubbled through the reaction mixture at 10 mL min 1. Ultra high purity Ar (99.999%, Praxair) was used in all experiments to minimize the amount of O₂ and N₂ originating from the carrier gas. Prior to the electrolysis, the system was purged with Ar during 1 h until GC showed only trace amount of O₂ and N₂, which then were used as a baseline. The gas products (N₂ and O₂) formed in a course of electrolysis were analyzed by gas chromatography (GC) using SRI MG-5 multiple gas analyzer connected to the cell through the ammonia trap containing 1 M H₂SO₄ solution (˜100 ml glass tube equipped with septa, containing ˜20 ml of acidic solution), preventing the NH₃ vapour getting into the GC columns and possible damaging of the instrument. Nitrate and nitrite concentrations were determined by ion chromatography (10) using Metrohm Eco IC equipped with an anion column using 3.2 mM Na₂CO₃ (>99.5%, ACP Chemicals)+1 mM NaHCO₃ (>99.7% VWR) solution in Milli-Q water as an eluent. The calibration curve standards, containing 1-10 ppm NO₃⁻/NO₂ were prepared from the commercially available solutions of these anions (1000 ppm, Sigma-Aldrich). The samples for IC were prepared by 100-times dilution of the reaction mixture (100 ul of the reaction mixture was taken from the cell for each measurement).

Calculation of faradaic efficiency of O₂ and N₂ formation:

The quantitative analysis of O₂ and N₂ was performed using a thermal conductivity detector (TCD). The Faradaic efficiency (FE) of the gas products was calculated¹⁴ as:

$$FE ( \% ) = \frac{{n}_{i} \times F \times {Φ}_{i} \times {F}_{m}}{I} , \qquad ( S5 )$$

where nᵢ is a number of the transferred electrons (nᵢ=4 for O₂ and 6 for N₂), F is the Faraday constant, ϕⁱ is the volume fraction of the gas product being quantified (calculated by calibrating the GC data using a diluted mixture of the gases of known concentrations), I is the current value at the beginning of the measurement, F m is the molar Ar gas flow rate.

Calculation of faradaic efficiency of nitrite and nitrate formation:

The quantitative analysis of nitrate and nitrite was performed using an ionic conductivity detector. The FE of the gas products was calculated as:

$$FE = \frac{{n}_{i} \times V \times C \times F}{Q \times {M}_{w}} , \qquad ( S6 )$$

where nᵢ is a number of the electrons transferred (nᵢ=6 for NO₂⁻ and 8 for NO₃), F is the Faraday constant, C is the concentration of nitrate/nitrate in the analyte in ppm, V is the total volume of the anolyte, Q is the total charge passed, and M_{w} is the molecular weight of nitrate/nitrate.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description but should be given the broadest interpretation consistent with the present specification as a whole. The disclosures of all prior art recited herein are incorporated herein by reference in their entirety.

### REFERENCE

1. L. F. Greenlee, Nature Energy, 2020, 5, 557-558.
2. J. Martinez-Dalmau, J. Berbel, R. Ordóñez-Fernández, Sustainability, 2021, 13, 5625.
3. J. W. Erisman, R. Otjes, A. Hensen, P. Jongejan, P. Bulk, A. Khlystov, H. Mals, S. Slanina, Atmos. Environ., 2001, 35, 1913-1922.
4. S. Guthrie, S. Giles, F. Dunkerley, H. Tabaqchali, A. Harshfield, B. Ioppolo, C. Manville, Impact of ammonia emissions from agriculture on biodiversity: An evidence synthesis, The Royal Society, 2018. https://www.rand.org/pubs/research_reports/RR2695.html.
5. J. Plautz, Ammonia, a poorly understood smog ingredient, could be key to limiting deadly pollution, Science, 2018. https://www.science.org/news/2018/09/ammonia-poorly-understood-smog-ingredient-could-be-key-limiting-deadly-pollution
6. E. Giannakis, J. Kushta, A. Bruggeman, J. Lelieveld, Environ. Sci. Eur, 2019, 31, 93.
7. S. N. Behera, M. Sharma, V. P. Aneja, R. Balasubramanian, Environ. Sci. Pollut. Res., 2013, 20, 8092-8131.
8. L. J. M. van der Eerden, Agric. Environ., 1982, 7, 223-235.
9. M. S. Romero-Guiza, J. Mata-Alvarez, J. M. C. Rivera, S. A. Garcia, rev.ion., 2016, 29, 7-26.
10. D. P. Van, T. Fujiwara, B. L. Tho, P. P. S. Toan, G. H. Minh, Environ. Eng. Res., 2020, 25, 1-17.
11. J. L. Campos, D. Crutchik, O. Franchi, J. P. Pavissich, M. Belmonte, A. Pedrouso, A. Mosquera-Corral, A. V. del Rio, Front. Sustain. Food Syst., 2019, 2, 91.
12. P. L. McCarty, J. Bae, J. Kim, Environ. Sci. Technol., 2011, 45, 7100-7106.
13. W. Rongwong, J. Lee, K. Goh, H. E. Karahan, T.-H. Bae, npj Clean Water, 2018, 1, 21.
14. M. Baldi, M. C. Collivigarelli, A. Abba, I. Benigna, Sustainability, 2018, 10, 3073.
15. M. Walker, K. Iyer, S. Heaven, C. J. Banks, Chem. Eng. J., 2011, 178, 138-145.
16. P. Costamagna, A. Giordano, Y. Lazzarini, M. Delucchi, G. Busca, J. Environ. Manage., 2020, 259, 109841.
17. N. Krakat, B. Demirel, R. Anjum, D. Dietz, Water Sci. Technol., 2017, 76, 1925-1938.
18. M. R. Adam, M. H. D. Othman, R. A. Samah, M. H. Puteh, A. F. Ismail, A. Mustafa, M. A. Rahman, J. Jaafar, Sep. Purif. Technol., 2019, 213, 114-132.
19. T. A. Pressley, D. F. Bishop, S. G. Roan, Environ. Sci. Technol., 1972, 6, 622-628.
20. C. T. Jafvert, R. L. Valentine, Environ. Sci. Technol., 1992, 26, 577-586.
21. G. Zhang, J. Ruan, T. Du, ACS EST Engg., 2021, 1, 310-325.
22. H. J. S. Finch, A. M. Samuel, G. P. F. Lane, Lockhart and Wiseman's Crop Husbandry Including Grassland (Eighth Edition), Woodhead Publishing, Cambridge, 2002.
23. S. Sinis̆a, Z. Nikola, T. 110, S. Z̆eljko, Burns, 2020, 46, 360-369.
24. R. Cope, in Veterinary Toxicology (Third Edition), ed. R. C. Gupta, Elsevier, Amsterdam, 2018, ch. 48, pp. 629-645.
25. Glacier FarmMedia. Anhydrous ammonia could be losing favour. https://www.manitobacooperator.ca/crops/anhydrous-ammonia-could-be-losing-favour-2/ (assessed October 2021)
26. E-commerce of chemical. https://www.echermi.com/ (assessed August 2021)
27. S. P. Ceccotti, Fertilizer Research, 1995, 117-125.
28. F. C. Menz, H. M. Seip, Environ Sci Policy, 2004, 7, 253-265.
29. X. V. Medvedeva, J. J. Medvedev, S. W. Tatarchuk, R. M. Choueiri, A. Klinkova, Green Chem., 2020, 22, 4456-4462.
30. X. V. Medvedeva, J. J. Medvedev, A. Klinkova, Adv. Energy Sustainability Res., 2021, 2, 2100001.
31. Á. Vass, B. Endrödi, C. Janáky, Curr. Opin. Electrochem., 2021, 25, 100621.
32. J. Jack, W. Zhu, J. L. Avalos, J. Gong, Z. J. Ren, Green Chem., 2021, DOI: 10.1039/D1GC02094C.
33. G. Jeerh, M. Zhang, S. Tao, J. Mater. Chem. A, 2021, 9, 727-752.
34. R. Lan, S. Tao, Front. Energy Res., 2014, 2, 35.
35. N. M. Adli, H. Zhang, S. Mukherjee, G. Wu, J. Electochem. Soc., 2018, 165, J3130-J3147.
36. A. Kapalka, A. Cally, S. Neodo, C. Comninellis, M. Wachter, K. M. Udert, Electrochem. Commun., 2010, 12, 18-21.
37. R. Wang, H. Liu, K. Zhang, G. Zhang, H. Lan, J. Qu, Chem. Eng. J., 2021, 404, 126795.
38. X. Jiang, D. Ying, X. Liu, M. Liu, S. Zhou, C. Guo, G. Zhao, Y. Wang, J. Jia, Electochim. Acta, 2020, 345, 136157.
39. M. Gonzalez-Reyna, M. S. Luna-Martinez, J. F. Perez-Robles, Nanotechnology, 2020, 31, 235706.
40. M.-H. Tsai, T.-C. Chen, Y. Juang, L.-C. Hua, C. Huang, Electrochem. Commun., 2020, 121, 106875.
41. F. Almomani, R. Bhosale, M. Khraisheh, A. Kumar, M. Tawalbeh, Int. J. Hydr. Energy, 2020, 45, 10398-10408.
42. Y.-J. Shin, W.-H. Huang, C. P. Huang, Electrochim. Acta, 2018, 263, 261-271.
43. A. Allagui, S. Sarfaz, S. Ntais, F. Al momani, E. A. Baranova, Int. J. Hydr. Energy, 2014, 39, 41-48.
44. Y.-J. Shin, C.-H. Hsu, Chem. Eng. J., 2021, 409, 128024.
45. S. W. Tatarchuk, R. M. Choueiri, X. V. Medvedeva, L. D. Chen, A. Klinkova, Chemosphere, 2021, 279, 130550.
46. S. Esposito, Materials, 2019, 12, 668.
47. M. Parashar, V. K. Shukla, R. Singh, J. Mater. Sci. Mater., 2020, 31, 3729-3749.
48. S. He, Q. Huang, Y. Zhang, L. Wang, Y. Nie, Ind. Eng. Chem. Res., 2015, 54, 1447-1451.
49. S. Xiao, J. Qu, X. Zhao, H. Liu, D. Wan, Water Res., 2009, 43, 1432-1440.
50. R. M. Choueiri, S. W. Tatarchuk, A. Klinkova, L. D. Chen, Electrochem. Sci. Adv., 2021. DOI: 10.1002/elsa.202100142.
51. T. L. Broder, D. S. Silvester, L. Aldous, C. Haracre, R. G. Compton, J. Phys. Chem. B, 2007, 111, 7778-7785.
52. Y. Wang, E. Laborda, R. G. Compton, J. Electroanal. Chem., 2012, 670, 56-61.
53. J. Speight, Lange's Handbook of Chemistry Seventeenth Edition, McGraw-Hill Education, New York, 2016.
54. M. Zhu, Y. Yang, S. Xi, C. Diao, Z. Yu, W. S. V. Lee, J. Xue, Small, 2021, 17, 2005616.
55. K. Endo, Y. Katayama, T. Miura, Electrochim. Acta, 2005, 50, 2181-2185.
56. H. Gerischer, A. Mauerer, J. Electroanal. Chem., 1970, 25, 421-433.
57. M. Fleischmann, K. Korinek, D. Pletcher, J. Electroanal. Chem. lnterf. Electrochem., 1971, 31, 39-49.
58. A. Allagui, S. Sarfraz, E. A. Baranova, Electrochim. Acta., 2013, 110, 253-259.
59. W. Chen, C. Xie, Y. Wang, Y. Zou, C.-L. Dong, Y.-C. Huang, Z. Xiao, Z. Wei, S. Du, C. Chen, B. Zhou, J. Ma, S. Wang, Chem, 2020, 6, 2974-2993.
60. H. Dotan, A. Landman, S. W. Sheehan, K. D. Malviya, G. E. Shter, D. A. Grave, Z. Arzi, N. Yehudai, M. Halabi, N. Gal, N. Hadari, C. Cohen, A. Rothschild, G. S. Grader, Nat. Energy, 2019, 4, 786-795.
61. Y. Wang, K. Jacobi, W.-D. Schone, G. Ertl, J. Phys. Chem. B, 2005, 109, 7883-7893.
62. T. Lan, Y. Zhao, J. Deng, J. Zhang, L. Shi, D. Zhang, Catal. Sci. Technol., 2020, 10, 5792-5810.
63. H. J. Schafer, Oxidation of organic compounds at the nickel hydroxide electrode in Electrochemistry I. Topics in Current Chemistry, Springer, Berlin, Heidelberg, 1987, vol. 142, pp. 101-129.
64. L.-F. Li, Y.-F. Li, Z.-P. Liu, ACS Catal., 2020, 10, 2581-2590.
65. L. Zhang, L. Wang, H. Lin, Y. Liu, J. Ye, Y. Wen, A. Chen, L. Wang, F. Ni, Z. Zhou, S. Sun, Y. Li, B. Zhang, Angew. Chem. Int. Ed., 2019, 58, 16820-16825.

We claim:

1. A system for electrochemical oxidation of ammonia comprising:
a divided cell having at least two compartments an anodic compartment and a cathodic compartment; said compartments separated by an anion exchange membrane (AEM);
the anodic compartment comprising an anode comprising a nickel containing catalyst and a first electrolyte for oxidative electrolysis of ammonia;
the cathodic compartment comprising a cathode and a second electrolyte for reductive electrolysis of hydrogen or carbon dioxide, and
wherein the anodic compartment has a pH of 9-12 and the cathodic compartment has a pH≥13.

2. The system of claim 1 wherein the nickel containing catalyst is Ni(OH)₂ or Ni(OH)Cl.

3. The system of claim 1 wherein the catholyte is potassium hydroxide, sodium hydroxide, or cesium hydroxide.

4. The system of claim 1 wherein the anolyte is potassium sulfate or dipotassium phosphate.

5. The system of claim 1 wherein the applied potential is greater than about 1.3V and less than about 2.1 V.

6. The system of claim 1 wherein the applied potential is a range of about 1.3 to about 2.0 V. vs RHE.

7. The system of claim 1 wherein the applied potential is about 1.7 to about 1.9 V to increase production of nitrate.

8. The system of claim 1 wherein the applied potential is about 1.4 to about 1.6 V to increase production of nitrite.

9. The system of claim 1 wherein the starting NH₃ concentration in the anode compartment is above about 1M to increased N₂ production.

10. The system of claim 1 wherein the starting NH₃ concentration in the anode compartment is below about 1M ammonia to increase nitrate and/or nitrite production.

11. The system of claim 1 wherein the temperature is in the range of about 5° C. to about 95° C.

12. The system of claim 1 wherein the temperature is in the range of about 50° C. to about 60° C. to increase nitrate production.

13. The system of claim 1 wherein the temperature is below 50° C. to increase nitrite production.

14. The system of claim 1 wherein the catalyst is supported on high surface area support wherein the high surface area support is a Ni foam or porous carbon.

15. The system of claim 1 wherein the nickel catalyst is doped with another metal and has the formula NiₓM₁₋ₓ(OH)₂ wherein M is one or more of Cr, Mn, Fe, Co, Cu, Zn, W, or Mo.

16. The system of claim 1 wherein the electrolysis is carried out in flow or batch set up.

17. The system of claim 1 wherein the anolyte is 0.1M K₂HPO₄, the starting ammonia concentration is 0.3M ammonia, the pH is approximately 11 and the resulting product is NH₄NO₃ ad K₂HPO₄ with a N—P—K—(S) ratio of about 10-42-39-(0).

18. A method for electrochemical co-production of hydrogen or syngas and nitrogen fertilizer, the method comprising:
providing a divided cell having at least two compartments an anodic compartment and a cathodic compartment; said compartments separated by an anion exchange membrane (AEM) the anodic compartment comprising a nickel based catalyst;
introducing ammonia in an electrolyte at pH 9-12 in the anodic compartment of the divided cell;
introducing water or wet CO₂ in an electrolyte at pH≥13 into the cathodic compartment of the divided cell; and
applying a potential to electrooxidize the ammonia into ammonium nitrate at the anode while reducing the water or wet CO₂ to hydrogen gas or syngas at the cathode.

19. The method of claim 18 wherein the electrolyte in the anodic compartment is potassium sulfate or dipotassium phosphate; the electrolyte in the cathodic compartment is potassium hydroxide and the applied potential is between about 1.9 and 2.1 V vs RHE.

20. A method for oxidizing a nitrogen containing compound comprising:
a first step of applying a potential to a nickel catalyst to from an activated catalyst of the form NiOOH, and then discontinuing the applied potential; and
a second step of contacting the activated catalyst with a solution comprising the nitrogen containing compound and an electrolyte;
whereby the nitrogen containing compound is oxidized without further application of potential.

21. The method of claim 20 wherein the nitrogen containing compound is ammonia or urea.

22. The method of claim 21 wherein the first and second step are repeated alternately.

23. The method of claim 21 wherein the method is conducted at ambient temperature without requiring a heating step.
